(19) United States
(12) Patent Application Publication
(10) Pub. No.: US 2025/0385455 A1
(43) Pub. Date: Dec. 18, 2025

(54) DROP DOWN CONTACT CONNECTOR

(71) Applicant: Molex, LLC, Lisle, IL (US)

(72) Inventors: Eric Sanders, Palos Heights, IL (US); Lie Chen, Maumelle, AR (US)

(21) Appl. No.: 19/228,834

(22) Filed: Jun. 5, 2025

Related U.S. Application Data
(60) Provisional application No. 63/661,069, filed on Jun. 18, 2024.
(60) Provisional application No. 63/683,714, filed on Aug. 16, 2024.

(51) Int. Cl. H01R 12/89

(52) U.S. Cl. CPC H01R 12/89

(57) ABSTRACT

Aspects of drop down contacts in connectors are described. An example connector includes a housing with a front port opening, a wafer assembly including terminal rows, a push bar, and a biasing component. The push bar is positioned in the housing and extends between the terminal rows. The biasing component pushes the push bar toward the front port opening of the housing and into contact with the rows of terminal conductors. The push bar maintains a minimal distance or clearance between opposing contact tips of the rows of terminal conductors even when no paddle card is inserted into the connector. When a paddle card is inserted into the front port opening, the paddle card pushes the push bar out of contact with the terminal conductors, so that the terminal conductors drop down upon contact surfaces of the paddle card.

### BACKGROUND

The amount of data processed by computers, computing systems, and computing environments continues to increase. For example, data centers can include hundreds of computing and networking systems interconnected using optical cables, copper cables, and various connectors, cable assemblies, and terminations between them. The data throughput of these interconnects is high and increasing. Many data centers incorporate a combination of 10 Gigabit Ethernet (10 GbE), 25 GbE, 50 GbE, and 100 GbE network interfaces and interconnects. 200 GbE, 400 GbE, and 800 GbE interconnection technologies are also being developed and deployed. Other interconnection solutions rely upon 56 Gigabit per second (Gb/s), 112 Gb/s, 224 Gb/s, 448 Gb/s interconnection technologies, and interconnection technologies are being developed to support even higher data rates.

It can be challenging to design interconnection system connectors, cables, cable assemblies, and related components for high data rate applications due to a number of competing concerns. Some high data rate interconnection systems rely upon differentially coupled signal pairs in which two conductors are arranged in a pair to transmit a differential signal. The signal being transmitted is embodied by the electrical difference measured between the conductor pair. Differential signaling can be helpful to avoid spurious signals and crosstalk and avoid inadvertent signaling modes among adjacent signal pairs. In connector interfaces, ground terminals can be relied upon to create a return path to electrical ground, provide shielding between differential pairs, and for other purposes.

A range of input/output (I/O) connectors are designed for power, data, and power and data interconnect systems, including board-to-board, wire-to-wire, and wire-to-board systems. A variety of designs exist for each type of system, depending on the requirements of the power and data communications environment in which the connectors are used. As one example, a wire-to-board system includes a free-end connector attached to a wire and a fixed-end connector attached to a board. A range of cable assemblies are also available for data interconnects. A variety of designs exist for each cable assembly, depending on the requirements of the data communications environment in which the connectors are used.

Connectors used in high data rate applications are typically designed to meet a range of mechanical and electrical requirements. Backplane applications, for example, depend upon connectors that adhere to certain mechanical and electrical requirements. Maintaining the mechanical and electrical requirements is important to mitigate resonances, improve crosstalk, improve insertion loss performance, and improve other signal integrity attributes, among other factors. The connectors used in such applications often incorporate one or more wafer assemblies to achieve the desired mechanical and electrical requirements. The wafer assemblies can include an insulative web that supports the terminal conductors in the wafer assemblies. The use of wafer assemblies can be helpful to manufacture connectors capable of achieving high data rates using a number of different assembly processes. It is still challenging, in any case, to design connectors for high data rate applications suitable for use in new systems, while also maintaining the desired mechanical and electrical characteristics for the transmission of data with integrity.

### SUMMARY

Aspects of drop down contacts in connectors are described. The concepts provide a way to shorten the contact tip length of terminal conductors and improve signal integrity in electrical connectors. The concepts also provide a way to shorten the stub length of contacts on paddle cards and improve signal integrity in connections. The connectors described herein include an additional component, described as a push bar in some examples, that maintains the opposing contact tips of terminal conductors in the connector a certain distance apart from each other. The push bar maintains a minimal distance or clearance between the opposing contact tips even when no paddle card is inserted into the connector.

An example connector includes a housing with a front port opening, a wafer assembly including terminal rows, a push bar, and a biasing component. The push bar is positioned in the housing and extends between the terminal rows. The biasing component pushes the push bar toward the front port opening of the housing and into contact with the rows of terminal conductors. The push bar maintains a minimal distance or clearance between opposing contact tips of the rows of terminal conductors even when no paddle card is inserted into the connector. The minimal distance or clearance is larger than a thickness of the paddle card for insertion into the front port opening in preferred examples. When a paddle card is inserted into the front port opening, the paddle card pushes the push bar out of contact with the terminal conductors, so that the terminal conductors drop down upon contact surfaces of the paddle card.

Another example connector includes a housing with a front port opening, a wafer assembly including terminal rows, a push bar, and a biasing component. The terminal rows include a first row of terminal conductors and a second row of terminal conductors in one example. The push bar is positioned in the housing and extends between the first row of terminal conductors and the second row of terminal conductors. The biasing component pushes the push bar toward the front port opening of the housing and into contact with the first row of terminal conductors and the second row of terminal conductors. The push bar maintains a minimal distance or clearance between the opposing contact tips of the rows of terminal conductors even when no paddle card is inserted into the connector.

In other aspects of the embodiments, the wafer assembly also includes a wafer insert and a ground shield. The wafer insert can be molded at least in part around the ground shield. The biasing component contacts the ground shield as an anchor to push the push bar toward the front port opening of the housing and into contact with the first row of terminal conductors and the second row of terminal conductors.

Among a range of different embodiments, the biasing component includes at least one single-bend spring finger formed from an elastic metal in one example. The biasing component includes at least one double-bend spring formed from an elastic metal in another example. The biasing component includes a spring formed or provided at each end of a bar in another example.

The push bar can include a contact bar and guide handles at opposite ends of the contact bar in some examples. The biasing component biases the contact bar into contact with the first row of terminal conductors and the second row of terminal conductors. The housing also includes datum channels formed in sides of the housing and extending towards the front port opening. The guide handles of the push bar are positioned in the datum channels and slide within the datum channels. The datum channels thus constrain the push bar to movement in only one direction.

The push bar includes a leading bumper bar, a trailing bumper bar, and a window between the leading bumper bar and the trailing bumper bar in another example. The terminal rows in the connector can also include a third row of terminal conductors and a fourth row of terminal conductors. The leading bumper bar of the bumper frame extends between the first row of terminal conductors and the second row of terminal conductors, and the trailing bumper bar of the bumper frame extends between the third row of terminal conductors and the fourth row of terminal conductors.

Another example connector includes a housing with a front port opening, a first row of terminal conductors and a second row of terminal conductors, a push bar, and a biasing component. The push bar extends between the first row of terminal conductors and the second row of terminal conductors, and the biasing component pushes the push bar toward the front port opening of the housing and into contact with the first row of terminal conductors and the second row of terminal conductors.

An example method includes maintaining a minimal clearance between a first row of terminal conductors and a second row of terminal conductors using a mechanical interference between the first row of terminal conductors and the second row of terminal conductors, and removing the mechanical interference between the first row of terminal conductors and the second row of terminal conductors. The method can also include dropping down the first row of terminal conductors and the second row of terminal conductors upon contact pads of a paddle card after removing the mechanical interference.

The mechanical interference can include a push bar. In that case, the method can include a biasing component pushing the push bar toward a front port opening of a housing of the connector and into contact with the first row of terminal conductors and the second row of terminal conductors for maintaining the minimal clearance. The biasing component can also include at least one single-bend spring finger formed from an elastic metal, at least one double-bend spring formed from an elastic metal, and/or other spring or elastic components.

In other aspects, the push bar can include a contact bar and guide handles at opposite ends of the contact bar. The method can include a biasing component pushing the contact bar into the contact with the first row of terminal conductors and the second row of terminal conductors. A housing of the connector can also include datum channels formed in sides of the housing and extending towards a front port opening of the housing. The method can also include the biasing component sliding the guide handles of the push bar within the datum channels to constrain the push bar to movement in only one direction.

Another example connector includes a housing with a front port opening, a wafer assembly including terminal rows, a push bar, and a biasing component. The terminal rows include a first row of terminal conductors and a second row of terminal conductors. The push bar is positioned in the housing and extends between the first row of terminal conductors and the second row of terminal conductors. The biasing component pushes the push bar against the housing. In some examples, the biasing component pushes the push bar against the housing, toward the front port opening of the housing, and into contact with the first row of terminal conductors and the second row of terminal conductors.

In other aspects, the biasing component includes an elastic member or elastic members positioned between a surface of the push bar and a surface of the housing. The biasing component can also include elastic members positioned between surfaces of the push bar and surfaces of the housing. In one example, the housing includes an upper housing and a lower housing. At least one of the upper housing and the lower housing includes an alignment post, and the biasing component pushes the push bar against an edge of the alignment post.

In other aspects, the biasing component includes one or more elastic clips. The elastic clips can be positioned around the housing. The housing can include anchor detents for securing the elastic clips around the housing. For example, the elastic clips can include elastic bars and mounting ends, and the mounting ends of the elastic clips can be secured in upper anchor detents and lower anchor detents of the housing. The elastic clips can be anchored to the housing at an angle with respect to a front port face of the housing in some cases.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a perspective view of an example connector according to various embodiments of the present disclosure.

FIG. 1B illustrates the connector shown in FIG. 1A with a paddle card positioned for insertion into the connector according to various embodiments of the present disclosure.

FIG. 1C illustrates the connector shown in FIG. 1A with a paddle card mated into the connector according to various embodiments of the present disclosure.

FIGS. 2A-2D illustrate perspective views of wafer assemblies in the connector shown in FIG. 1A according to various embodiments of the present disclosure.

FIGS. 3A-3C illustrate an example push bar assembly of the connector shown in FIG. 1A according to various embodiments of the present disclosure.

FIGS. 4A-4C illustrate another example of a push bar assembly that can be relied upon in the connector shown in FIG. 1A according to various embodiments of the present disclosure.

FIG. 5A illustrates the sectional view designated A-A of the housing of the connector shown in FIG. 1A according to various embodiments of the present disclosure.

FIG. 5B illustrates the sectional view designated A-A of the housing and the push bar of the connector shown in FIG. 1A according to various embodiments of the present disclosure.

FIG. 6 illustrates the sectional view of the wafer assemblies designated B-B in FIG. 2A according to various embodiments of the present disclosure.

FIG. 7 illustrates a sectional view of other wafer assemblies including terminal conductors with longer contact tips.

FIG. 8 illustrates examples of other terminal conductors having different contact tip lengths according to various embodiments of the present disclosure.

FIG. 9 illustrates a push bar and terminal conductors designed for drop down contact tips according to various embodiments of the present disclosure.

FIG. 10 illustrates a perspective view of an example connector according to various embodiments of the present disclosure.

FIG. 11A illustrates a perspective view of wafer assemblies in the connector shown in FIG. 10 according to various embodiments of the present disclosure.

FIG. 11B illustrates a side view of the wafer assemblies in the connector shown in FIG. 10 according to various embodiments of the present disclosure.

FIG. 11C illustrates another view of the wafer assemblies in the connector shown in FIG. 10 according to various embodiments of the present disclosure.

FIGS. 12A and 12B illustrate an example push bar assembly of the connector shown in FIG. 10 according to various embodiments of the present disclosure.

FIG. 13 illustrates another example push bar that can be relied upon in the connector shown in FIG. 10 according to various embodiments of the present disclosure.

FIG. 14 illustrates an example assembly approach for connectors according to various embodiments of the present disclosure.

FIG. 15 illustrates a perspective view of another example connector according to various embodiments of the present disclosure.

FIG. 16 illustrates a perspective view of wafer assemblies in the connector shown in FIG. 15 according to various embodiments of the present disclosure.

FIGS. 17A and 17B illustrate an example push bar of the connector shown in FIG. 15 according to various embodiments of the present disclosure.

FIG. 18 illustrates a perspective view of the housing and push bar of the connector shown in FIG. 15 according to various embodiments of the present disclosure.

FIG. 19 illustrates a perspective view of another example connector according to various embodiments of the present disclosure.

FIG. 20 illustrates a perspective view of wafer assemblies in the connector shown in FIG. 19 according to various embodiments of the present disclosure.

FIGS. 21A and 21B illustrate an example push bar assembly of the connector shown in FIG. 18 according to various embodiments of the present disclosure.

FIGS. 22A and 22B illustrate top and bottom views of the connector shown in FIG. 19 according to various embodiments of the present disclosure.

FIGS. 22C and 22D illustrate other top and bottom views of the connector shown in FIG. 19 according to various embodiments of the present disclosure.

FIG. 23 illustrates a perspective view of the housing and push bar of the connector shown in FIG. 15 according to various embodiments of the present disclosure.

FIG. 24 illustrates an example chart of insertion loss resonance versus tip length for different tip lengths according to various embodiments of the present disclosure.

### DETAILED DESCRIPTION

Connectors used in high data rate applications are typically designed to meet a range of mechanical and electrical requirements. Maintaining the mechanical and electrical requirements is important to mitigate resonances, improve crosstalk, improve insertion loss performance, and improve other signal integrity attributes, among other factors. The connectors used in high data rate applications often incorporate one or more wafer assemblies to achieve certain mechanical and electrical requirements, such as industry standard requirements. The wafer assemblies include rows of signal and ground terminal conductors for data communications. Each terminal conductor includes a contact tip at one end. The contact tip ends of terminals in connectors have been manufactured to include curved and relatively long tips in many cases. The long and curved tips have facilitated reliable mating with paddle cards in some applications. However, longer contact tips can result in diminished electrical performance, such as increased insertion loss, and the effect is mor pronounced in connectors designed to accommodate faster speeds, such as 224 Gb/s and 448 Gb/s interconnection technologies.

The concepts described herein provide a way to shorten the contact tip length of terminal conductors and improve signal integrity in electrical connectors. The concepts also provide a way to shorten the stub length of contacts on paddle cards and improve signal integrity in connections. The connectors described herein include an additional component, described as a push bar in some examples, that maintains the opposing contact tips of terminal conductors in the connector a certain distance apart from each other. The push bar maintains a minimal distance or clearance between the opposing contact tips even when no paddle card is inserted into the connector.

An example connector includes a housing with a front port opening, a wafer assembly including terminal rows, a push bar, and a biasing component. The terminal rows include a first row of terminal conductors and a second row of terminal conductors in one example. The push bar is positioned in the housing and extends between the first row of terminal conductors and the second row of terminal conductors. The biasing component pushes the push bar toward the front port opening of the housing and into contact with the first row of terminal conductors and the second row of terminal conductors. The push bar maintains a minimal distance or clearance between the opposing contact tips of the rows of terminal conductors even when no paddle card is inserted into the connector.

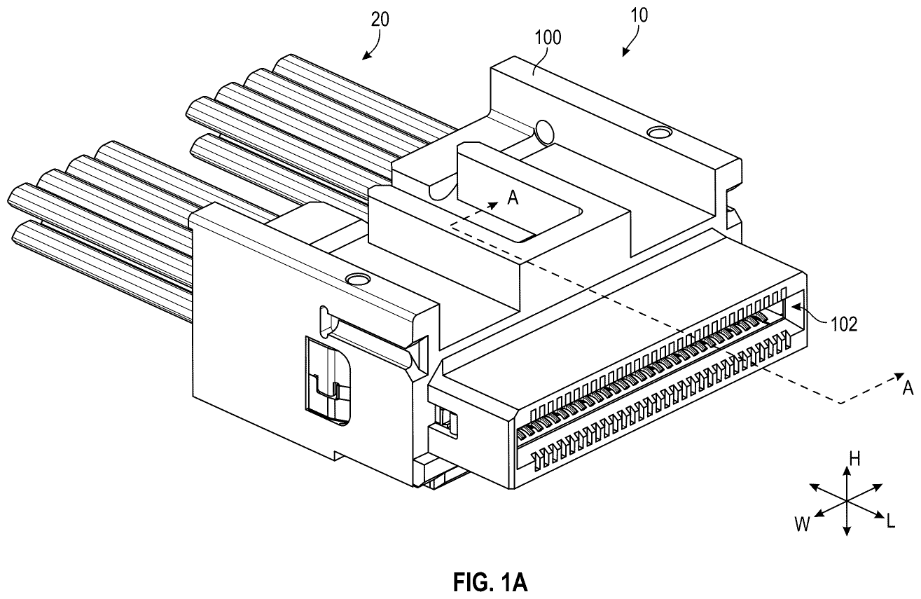

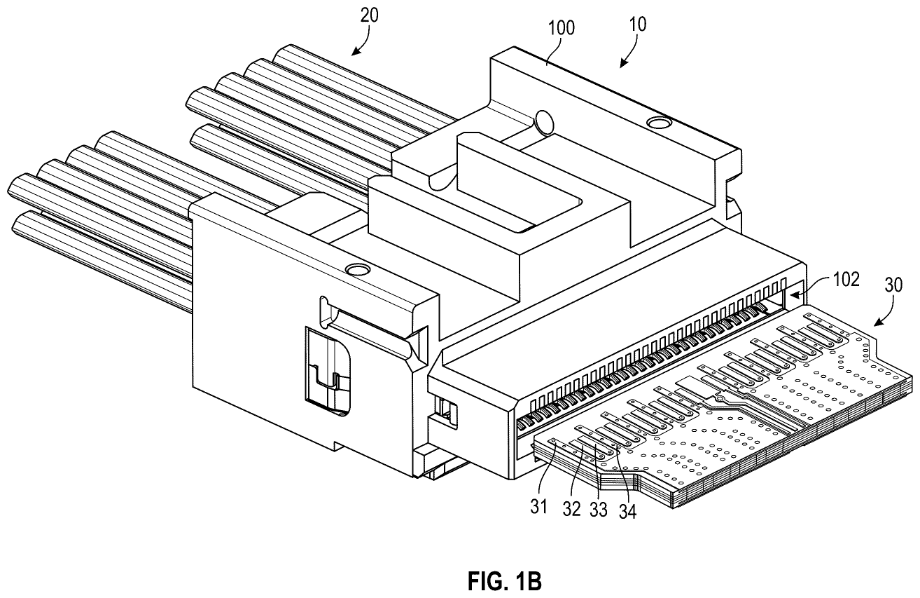

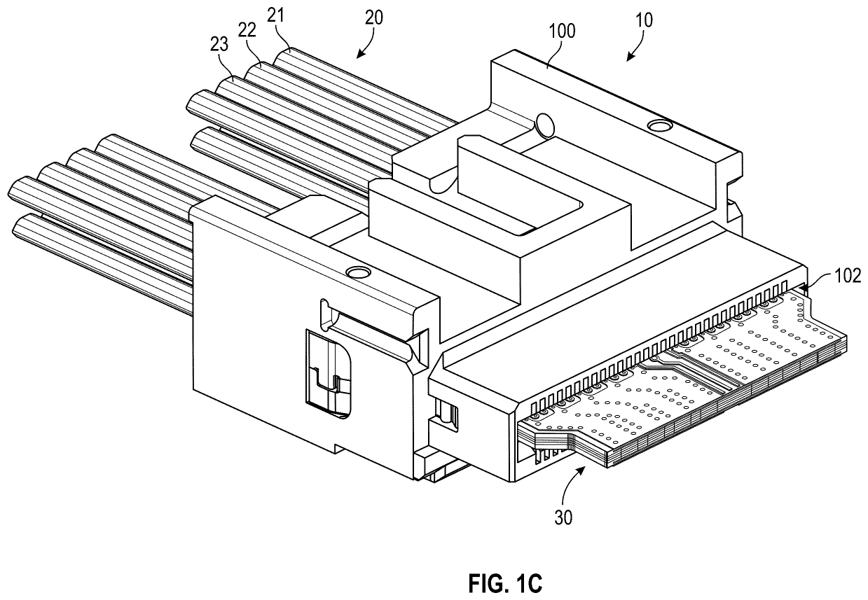

Turning to the drawings, FIG. 1A illustrates a perspective view of an example connector 10 according to various embodiments of the present disclosure. The connector 10 is shown to have a length, a width, and a height in the directions shown in FIG. 1A. However, the connector 10 is illustrated as a representative example and is not drawn to any particular scale or size. The shape, size, proportion, and other characteristics of the connector 10 can vary as compared to that shown. For example, the connector 10 can accommodate larger or smaller rows of terminals (e.g., be wider or narrower), and other variations are within the scope of the examples described herein. A number of connectors similar to the connector 10 can also be arranged and used together for higher data rate interconnections in some cases. One or more parts or components of the connector 10, as illustrated in the drawings and described below, can be omitted in some cases. The connector 10 can also include other parts or components that are not illustrated or described.

The connector 10 is designed to establish and maintain electrical connections with contacts on a paddle card interface. The connector 10 includes a housing 100 with a front port opening 102. A number of wafer assemblies, rows of terminal conductors, a push bar, and other components are positioned and secured within the housing 100. The housing 100 can be formed from a plastic, such as liquid crystal polymer (LCP), polyethylene (PE), polytetrafluoroethylene (PTFE), fluoropolymer, or other plastic or insulating material(s). The housing 100 can also be formed, in whole or in part, from conductive materials including metal(s), and the housing 100 can also be formed from combinations of insulating and conductive materials in some cases. The housing 100 can be formed by any suitable additive or subtractive manufacturing techniques, such as molding, diecasting, injection molding, printing, and other techniques. In some cases, certain surfaces or surface areas of the housing 100 can be plated with a plating metal or metals for conductivity, and the housing 100 can be embodied as a plated plastic component in some cases. The housing 100 can also be formed as a single integrated component or part or as two or more parts or pieces that can be assembled together in various embodiments.

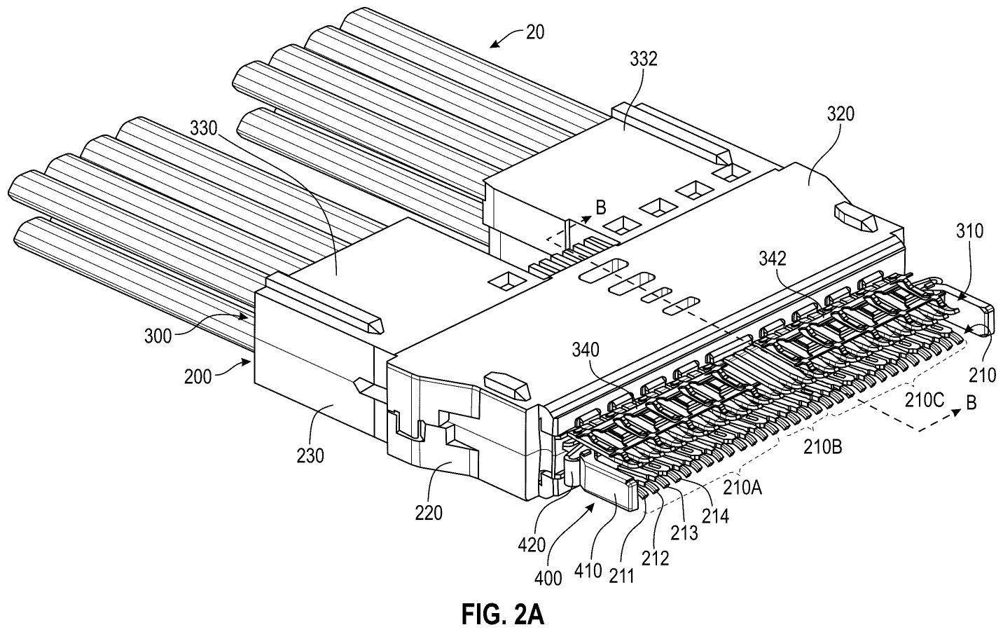

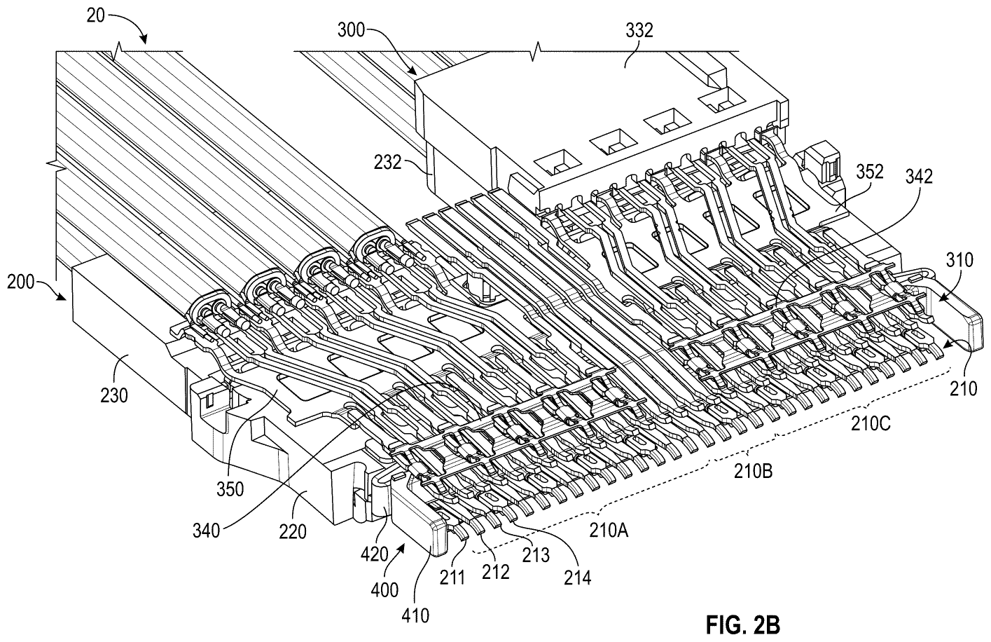

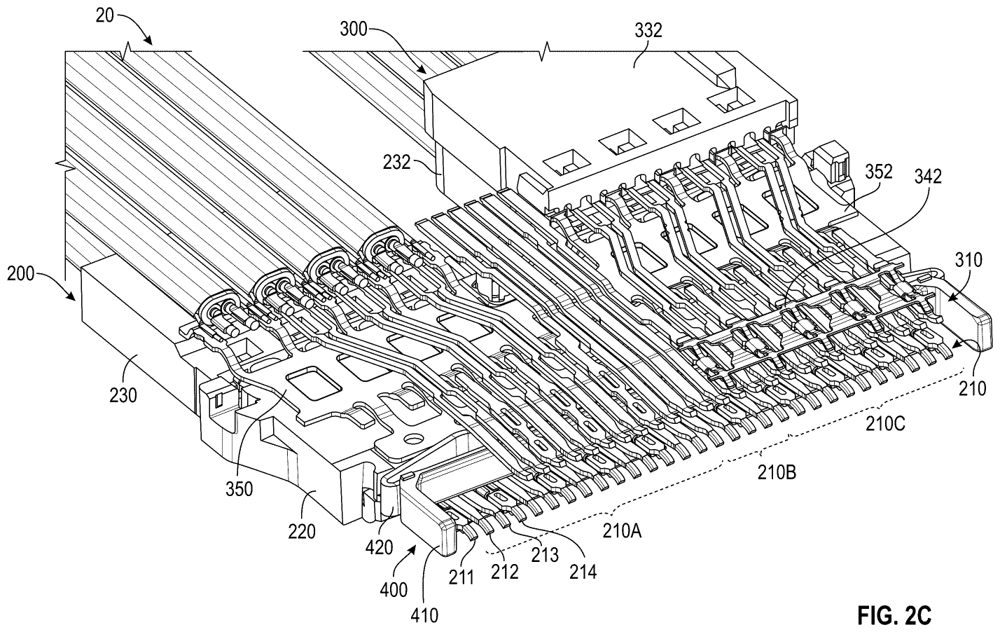

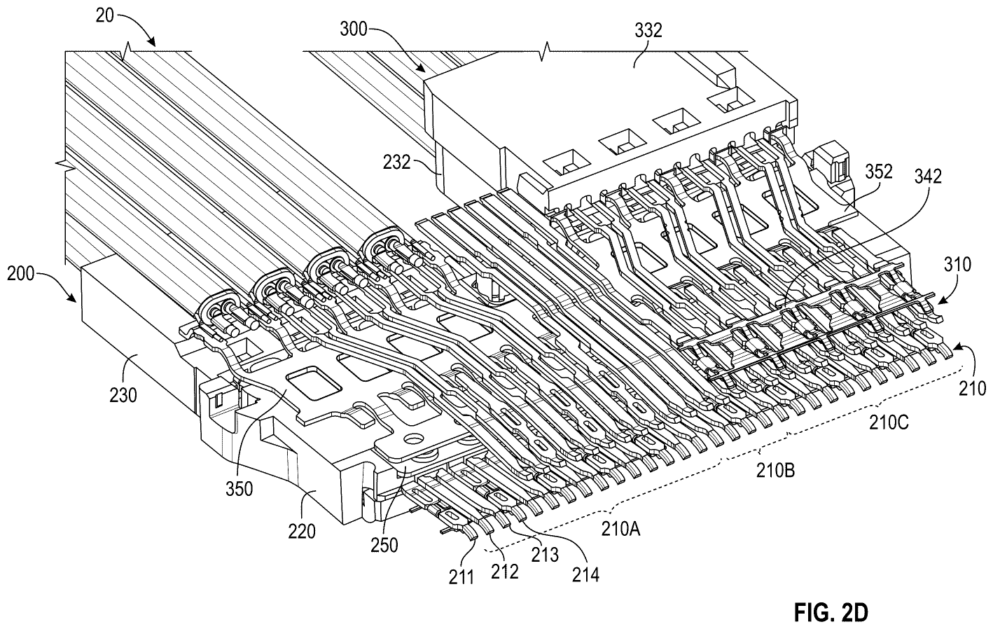

A cable bundle 20 extends to the back of the connector 10. Signal and ground or drain conductors of the cables in the cable bundle 20 are electrically terminated to signal and ground terminal conductors of the connector 10. The terminal conductors in the connector 10 extend between the front port opening 102 to the conductors of the cables in the cable bundle 20, as also described below with reference to FIG. 2B. Each terminal conductor in the connector 10 is formed of conductive metal material(s). The terminal conductors are elastic and will bend or flex to some extent based on an applied force or mechanical interference with another component. The terminal conductors will also return to their original position after the external force or component is removed.

The cable bundle 20 includes a number of cables with signal and ground or drain conductors. In one example, the cable bundle 20 includes a bundle of twinaxial cables, also called twinax cables. Each twinax cable includes a pair of conductors surrounded by a dielectric insulator or insulating material, a shield, one or more drain conductors, a jacket, and possibly other components. Twinax cables can be particularly suited for use in short-range, high-speed differential data signaling applications. The cable bundle 20 can be embodied by cables other than twinax cables in some cases, however, including twisted pair cables, shielded twisted pair cables, single-conductor cables, shielded single-conductor cables, single-conductor coaxial cables, and other types of cables.

The paddle card interface of a Small Form Factor Pluggable (SFP), Octal Small Form Factor Pluggable (OSFP), Quad Small Form Factor Pluggable (QSFP), CDFP, or related pluggable module of a cable assembly can be inserted into the front port opening 102 of the connector 10 according to the examples described herein. The paddle card interface can be embodied as a type of printed circuit board (PCB)-style interface, as would be understood in the field. However, related paddle card interfaces of other types of cables and cable assemblies can also be inserted into the front port opening 102 of the connector 10. Paddle card interfaces of other interconnect components, assemblies, and systems (i.e., beyond or beside cable assemblies) can also be inserted into the front port opening 102 of the connector 10.

According to aspects of the embodiments, opposing contact tips of the terminal rows in the connector 10 are maintained a certain distance apart from each other, even when no paddle card is present in the front port opening 102. A push bar is positioned within the housing 100 between first and second rows of terminal conductors in the connector 10. The push bar maintains the opposing contact tips of the first and second rows of terminal conductors a certain distance apart from each other, even when no paddle card is present in the front port opening 102, to provide a predetermined and minimal clearance between the opposing contact tips of the terminal rows. With the predetermined clearance, the lengths of the contact tips can be reduced, and the contact tips are still able to slide over the leading edge of and upon contact pads of any paddle card inserted into the front port opening 102 of the connector 10. In some cases, the predetermined clearance can be larger than the thickness of the paddle card. When the paddle card is inserted into the connector, the end of the paddle card pushes against the push bar, recessing it further into the connector 10. With the push bar recessed away, the terminal conductors are free to spring down upon the contacts of the paddle card. These and other aspects of the embodiments are described below. The concepts are not limited to use in the type or style of the connector 10 shown in FIG. 1A. The contacts described herein can be implemented in a range of different types and styles of connectors, including connectors designed for surface mounting on PCBs, having through-hole leads on a mounting side, and other types of connectors.

FIG. 1B illustrates the connector 10 shown in FIG. 1A with a paddle card 30 positioned for insertion into the front port opening 102 of the connector 10. FIG. 1C illustrates the connector 10 with the paddle card 30 inserted and mated into the connector 10. The paddle card 30 can be embodied as the PCB-style interface of an SFP, OSFP, QSFP, or related pluggable module, although the paddle card 30 can also be embodied as other types of interfaces. The paddle card 30 includes contacts or contact traces on both a top side or surface and a bottom side or surface. As shown in FIG. 1B, the paddle card 30 includes contact pads 31-34, among others, on a top surface. The paddle card 30 also includes contact pads on a bottom surface (not shown in FIGS. 1B and 1C).

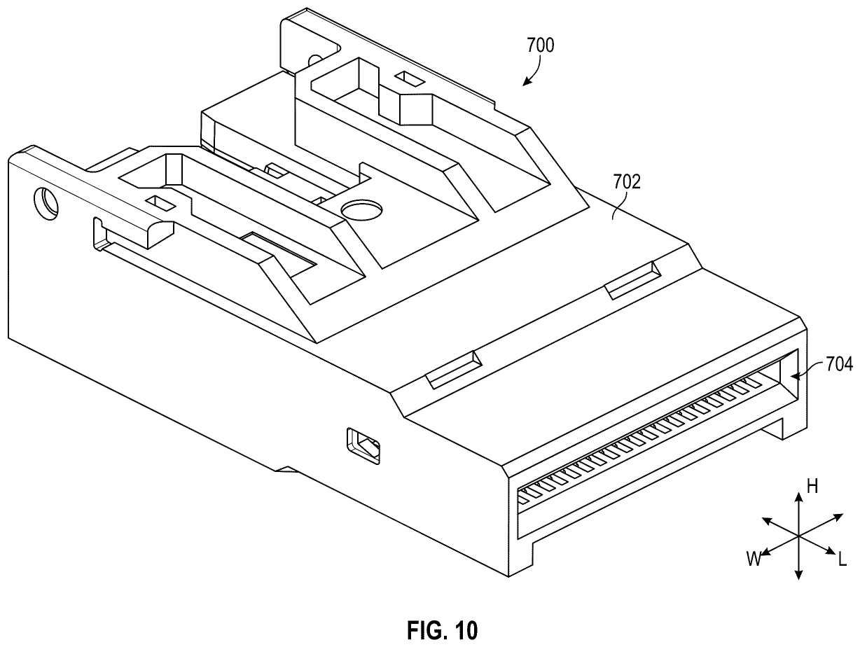

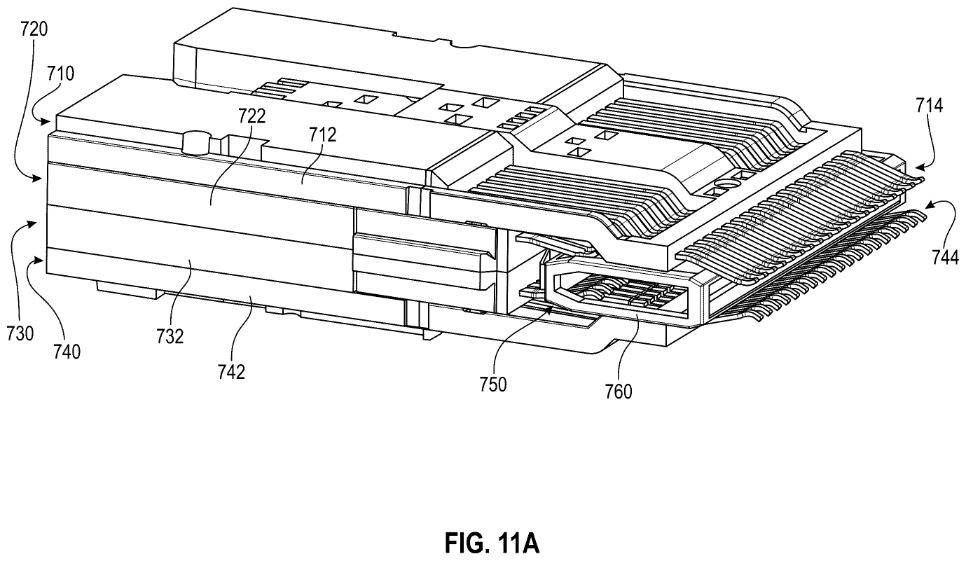

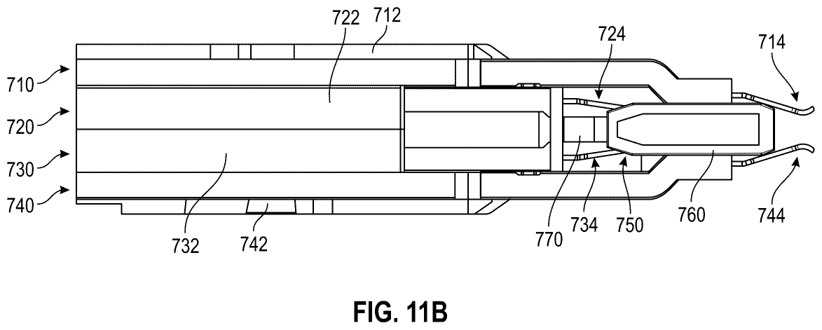

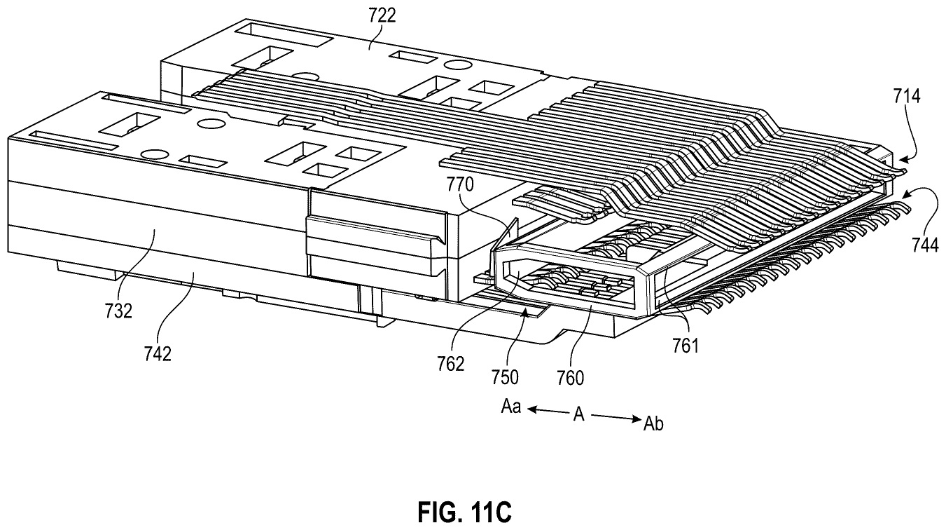

FIG. 2A illustrates a perspective view of the wafer assemblies 200 and 300 of the connector 10 shown in FIG. 1A. The wafer assemblies 200 and 300 of the connector 10 can also be referred to collectively as a wafer assembly of the connector 10. The housing 100 is omitted from view in FIG. 2A, so that the wafer assemblies 200 and 300 are visible. The connector 10 includes two wafer assemblies 200 and 300 in the example shown, and connectors with more wafer assemblies are described below with reference to FIGS. 10, 11A, and 11B. The first wafer assembly 200 includes the terminal row 210, the wafer insert 220, and cable inserts 230 and 232 (see FIG. 2B). The second wafer assembly 300 includes the terminal row 310, the wafer insert 320, and cable inserts 330 and 332. The wafer assemblies 200 and 300 are illustrated as representative examples and are not drawn to any particular scale or size. The shape, size, proportion, and other characteristics of the wafer assemblies 200 and 300 can vary as compared to that shown. For example, the wafer assemblies 200 and 300 can accommodate larger or smaller rows of terminals (e.g., be wider or narrower), and other variations are within the scope of the examples described herein.

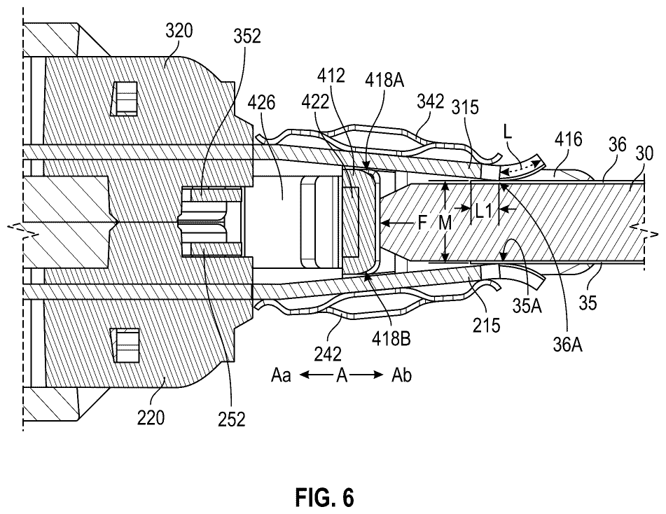

The first wafer assembly 200 supports, spaces, and aligns terminal conductors in the terminal row 210. The second wafer assembly 300 supports, spaces, and aligns terminal conductors in the terminal row 310. The ends of the terminal conductors in the terminal row 210 extend out from a side of the wafer insert 220, as also described below with reference to FIG. 6. Similarly, the ends of the terminal conductors in the terminal row 310 extend out from one side of the wafer insert 320. The terminal rows 210 and 310 extend out and away from the wafer inserts 220 and 320, respectively, in a cantilevered arrangement.

Each of the terminal rows 210 and 310 includes a row of terminal conductors, including signal conductors, power conductors, and ground conductors. Each of the signal, power, and ground conductors in the terminal rows 210 and 310 includes a tip or lead contact at one distal end (i.e., positioned within the front port opening 102 of the connector 10), a tail contact at another distal end, and a conductor body that extends between the tip and tail contacts. The signal and power conductors in the terminal rows 210 and 310 are electrically isolated from each other, and electrically isolated from the ground conductors, within the connector 10. Each of the signal conductors in the terminal rows 210 and 310 extends from a tip or lead contact at the front port opening 102 of the connector 10 to a signal conductor in one of the cables in the cable bundle 20, as also shown in FIGS. 2B-2D and described below. The ground conductors in the terminal rows 210 and 310 extend from the contact tips at the front port opening 102 to a ground path assembly, which is also described below.

To form the terminal row 210, a leadframe including the terminal row 210 can be formed (e.g., stamped, sheared, or otherwise formed) from a flat sheet of metal. The flat sheet of metal can be plated with one or more plating metals in some cases. The leadframe and the terminal row 210 can be pressed or bent into the shape of the terminal row 210 shown in FIGS. 2A-2D. The leadframe can be arranged with other components, including ground shields, and placed into a mold. A plastic material, such as LCP, PE, PTFE, fluoropolymer, or other plastic or insulating material(s) can be injected into the mold to form the wafer insert 220 around the terminal row 210. The terminal row 210 can then be sheared or cut away from the leadframe, and the individual terminal conductors of the terminal row 210 can be further bent or otherwise formed to the shape as illustrated if needed. The terminal row 310 can be formed in a similar way.

Referring to FIG. 2A, the terminal row 210 includes a first group 210A of terminal conductors, a second group 210C of terminal conductors, and a central group 210B of terminal conductors between the first group 210A and the second group 210C. The groups 210A and 210C include ground and signal conductors. For example, the group 210A includes a ground conductor 211, a differential pair of signal conductors 212 and 213, and a ground conductor 214. The conductors 211-214 include contact tips positioned at the front port opening 102 of the connector 10. The conductors 211 and 214 are ground conductors in the terminal row 210, and the conductors 212 and 213 are signal conductors in the terminal row 210. The signal conductors 212 and 213 are positioned between the ground conductors 211 and 214, as shown.

The first group 210A of the terminal row 210 includes eight (8) signal conductors and five (5) ground conductors, with each pair of the signal conductors being positioned side-by-side between two ground conductors. The second group 210C of the terminal row 210 also includes eight (8) signal conductors and five (5) ground conductors, with each pair of the signal conductors being positioned side-by-side between two ground conductors. The central group 210B of terminal conductors includes power conductors and, in some cases, can include ground or signal conductors. The terminal row 310 includes a similar arrangement of signal, ground, and power conductors as compared to the terminal row 210. As noted above, however, the wafer assemblies can accommodate larger or smaller rows of terminals (e.g., be wider or narrower), and other variations are within the scope of the examples described herein.

The contact tips of the terminal row 210 face the contact tips of the terminal row 310. The spacing or pitch between the contact tips is the same in both the terminal rows 210 and 310 in the example shown. The terminal conductors in the terminal row 210 can be offset from those in the terminal row 310 in some cases, such that the contact tips are offset between the rows. In other cases, the terminal conductors in the terminal rows 210 and 310 may have the same pitch and be aligned (i.e., not staggered) with respect to each other. In still other cases, the terminal conductors in the terminal rows 210 and 310 may have different contact tip pitches as compared to each other.

As noted above, the wafer mold insert 220 can be formed from a plastic, such as LCP, PE, PTFE, fluoropolymer, or other plastic or insulating material(s) and can be molded in part around the terminal conductors in the terminal row 210. The cable inserts 230 and 232 can be formed from a similar plastic material and be molded in part around a subset of the cables in the cable bundle 20. The wafer insert 320 can also be formed from a plastic material and be molded in part around the terminal row 310. The cable inserts 330 and 332 can be formed from a similar plastic material and be molded around a subset of the cables in the cable bundle 20.

Each of the wafer assemblies 200 and 300 also includes a ground path assembly. Referring to FIG. 2B, the wafer insert 320 and cable insert 330 are omitted from view, so that the ground path assembly of the second wafer assembly 300 is visible. The ground path assembly of the second wafer assembly 300 includes the flexible shields 340 and 342 and the rigid shields 350 and 352. A subset of the twinax cables in the cable bundle 20 are electrically coupled to the terminal row 310 and the ground path assembly of the second wafer assembly 300, as shown in FIG. 2B. The drain conductors in those twinax cables are electrically coupled (e.g., welded, soldered, sintered, etc.) to the rigid shields 350 and 352. The rigid shields 350 and 352 extend under and shield the signal conductors in the terminal row 310, as also shown in FIG. 2B. The wafer insert 320 is molded or otherwise formed around parts of the rigid shields 350 and 352, although front edges of the rigid shields 350 and 352 are exposed beyond the wafer insert 320, as described in further detail below with reference to FIG. 6. The flexible shield 340 is positioned over a first group of terminal conductors in the terminal row 310, and the flexible shield 342 is positioned over a second group of terminal conductors in the terminal row 310. The flexible shields 340 and 342 are secured and electrically coupled to ground terminals in the terminal row 310 and span and extend over signal conductors in the terminal row 310.

A push bar assembly 400 is also illustrated in FIGS. 2A and 2B. The push bar assembly 400 includes an insulative or non-conductive push bar 410 and a biasing component 420. As described in further detail below, the biasing component 420 includes an elastic or spring member that is capable of providing a spring bias or force. The biasing component 420 pushes the push bar 410 toward the front port opening 102 of the connector 10. Based on the force provided from the biasing component 420, the push bar 410 contacts and pushes against inner surfaces of the terminal conductors in the terminal rows 210 and 310. The push bar 410 also maintains the contact tips of the terminal rows 210 and 310 a certain distance apart from each other, particularly when no paddle card is inserted into the front port opening 102 of the connector 10. The push bar assembly 400 thus provides a predetermined and minimal clearance between the opposing contact tips of the terminal rows 210 and 310. Additional aspects of the push bar assembly 400 are described below with reference to FIG. 6.

FIG. 2C illustrates another view of the wafer assemblies 200 and 300 of the connector 10 shown in FIG. 1A. In FIG. 2C, a subset of the terminals from the terminal row 310 are omitted from view, so that more of the push bar assembly 400 is visible. As described above with reference to FIG. 2A, the contact tip ends of the terminal conductors in the terminal rows 210 and 310 extend out and away from the wafer inserts 220 and 320, respectively, in a cantilevered arrangement. Without any external forces applied to them, the contact tips of the terminal conductors in the terminal rows 210 and 310 are formed to bend toward and, possibly, contact each other. However, the terminal conductors in the terminal rows 210 and 310 are also elastic and will bend or flex to some extent based on an applied force or mechanical interference with another component. The terminal conductors will also return to their original position after the external force or component is removed.

As shown in FIG. 2C, the push bar 410 of the push bar assembly 400 extends in the open space between the terminal rows 210 and 310. The push bar 410 provides a mechanical interference between the terminal conductors in the terminal rows 210 and 310. Particularly, the biasing component 420 of the push bar assembly 400 pushes the push bar 410 toward the front port opening 102 of the connector 10, and the push bar 410 pushes against inner surfaces of the terminal conductors in the terminal rows 210 and 310. The inner surfaces of the terminal conductors contact and rest upon the push bar 410 in the arrangement shown in FIG. 2C. The push bar 410 acts as a mechanical interference and maintains a minimal clearance between the opposing contact tips of the terminal rows 210 and 310.

FIG. 2D illustrates another view of the wafer assemblies 200 and 300 of the connector 10 shown in FIG. 1A. In FIG. 2D, a subset of the terminals from the terminal row 310 and the push bar assembly 400 are omitted from view. The front edges of the rigid shield 250 of the first wafer assembly 200 and the rigid shield 350 of the second wafer assembly 300 are partly visible in FIG. 2D. As described in further detail below, the biasing component 420 contacts and pushes against the front edges of the rigid shields 250, 252, 350, and 352, and contacts and pushes against the push bar 410. In turn, push bar 410 pushes against inner surfaces of the terminal conductors in the terminal rows 210 and 310. The push bar 410 also slides within datum channels formed in the housing 100, and the datum channels are described below.

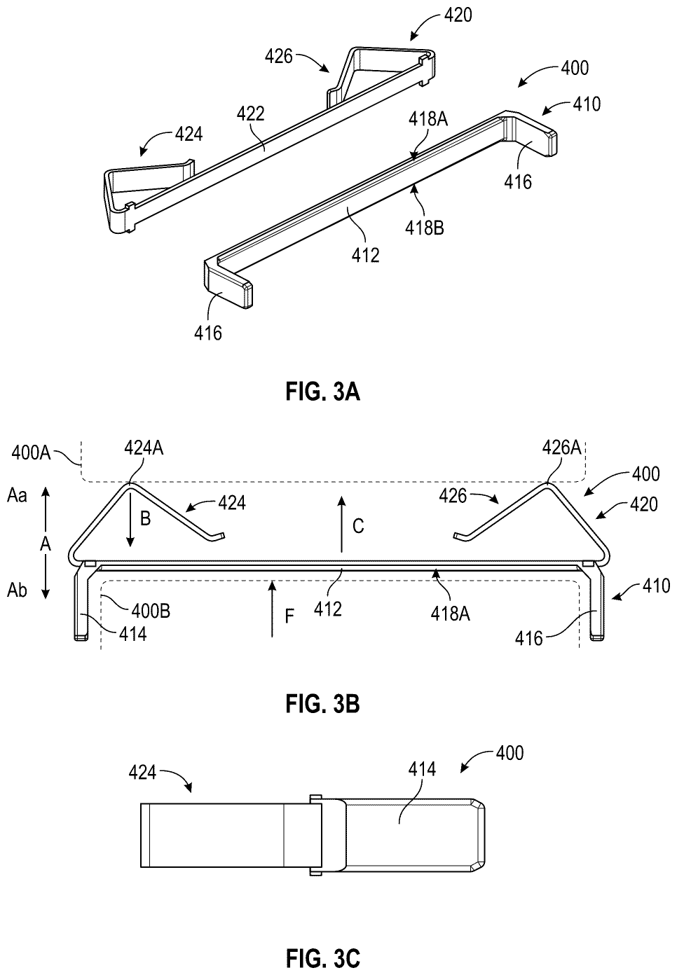

FIG. 3A illustrates the push bar assembly 400 of the connector 10 shown in FIG. 1A. The biasing component 420 is separated from the push bar 410 in FIG. 3A. FIG. 3B illustrates a top view of the push bar assembly 400, and FIG. 3C illustrates a side view of the push bar assembly 400. The push bar assembly 400 is illustrated as a representative example and is not drawn to any particular scale or size. The shape, size, proportion, and other characteristics of the push bar assembly 400, the push bar 410, and the biasing component 420 can vary as compared to that shown. The push bar assembly 400 can be larger, smaller, formed from other materials, and include additional or different components as compared to those shown in FIGS. 3A-3C and described below.

The biasing component 420 can be formed (e.g., stamped, sheared, or otherwise formed) from a flat sheet of metal and bent into the form shown in FIGS. 3A-3C. The push bar 410 can be formed from LCP, PE, PTFE, fluoropolymer, cured epoxy, rubber, or other insulating material(s). In some cases, the push bar 410 can be formed from a combination of different materials, such as a combination or LCP and rubber. The push bar 410 includes guide handles 414 and 416 at opposite ends of a contact bar 412. The contact bar 412 also includes chamfered or rounded corner surfaces 418A and 418B at opposing leading edges of the contact bar 412. The biasing component 420 includes double-bend spring ends 424 and 426 (also “spring ends 424 and 426”) at opposite ends of a bias bar 422. The push bar 410 can be molded in part around the biasing component 420, or the push bar 410 and biasing component 420 can be secured together in other ways (for example, the biasing component can be mounted to the housing and configured to engage the push bar).

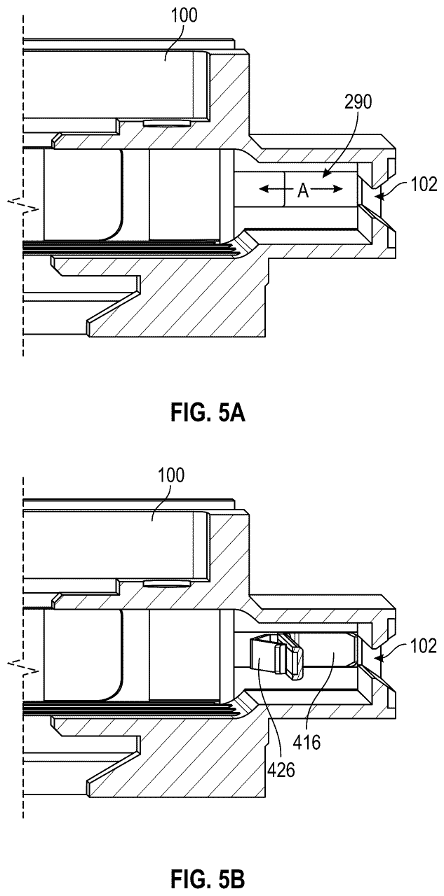

FIG. 3B illustrates dashed outlines 401A and 401B. The outline 401A is representative of the front edges of the rigid shields of the wafer assemblies 200 and 300 in the connector 10. More particularly the outline 401A is representative of the front edges of the rigid shields 250, 252, 350, and 352. The outline 401B is representative of the leading end or edge of the paddle card 30 (see FIGS. 1B and 1C). As also described below with reference to FIGS. 5A and 5B, the guide handles 414 and 416 of the push bar 410 are positioned within datum channels in the sides of the housing 100 when the connector 10 is assembled. Within those datum channels, the push bar 410 is limited or constrained to motion in the “A” direction only.

Further, as shown in FIG. 3B, the bends 424A and 426A of the spring ends 424 and 426 can contact the front edges of the rigid shields 250, 252, 350, and 352, represented by the dashed outline 401A. The rigid ground shields 250, 252, 350, and 352 act as a type of anchor or foundation against which the spring ends 424 and 426 can push and spring against. Being formed from an elastic metal material, the spring ends 424 and 426 can be compressed in the direction “B” shown in FIG. 3B between the push bar 410 and the front edges of the rigid shields 250, 252, 350, and 352. The spring ends 424 and 426 can be compressed when a force “F” is provided against the push bar 410. The force “F” can be provided by contact between the leading edge of the paddle card 30 and the push bar 410. In that case, the spring ends 424 and 426 can be compressed between the rigid shields 250, 252, 350, and 352 and the push bar 410 based on the force “F” applied from the paddle card 30 being inserted into the front end port 102 of the connector 10.

During compression, the push bar 410 will move towards “Aa” in the direction “A.” When the paddle card 30 is removed from the connector 10 and the force “F” is no longer present, then the spring ends 424 and 426 can elastically return back to the form shown in FIG. 3B. In that case, the spring ends 424 and 426 of the biasing component 420 can expand against the contact with the rigid shields 250, 252, 350, and 352. The push bar 410 will move back towards “Ab” in the direction “A” in that case. When the push bar 410 moves back towards the position “Ab,” the push bar 410 will contact and push against inner surfaces of the terminal rows 210 and 310, creating a minimal clearance between the opposing contact tips of the terminal rows 210 and 310. The biasing component 420 is one example of an elastic spring component that is capable of providing a spring bias or force for the push bar 410. The embodiments are not limited to using the biasing component 420, however, and other arrangements of coiled springs, elastic bends in metal components, and other elastic and spring components can be relied upon.

The biasing component 420 shown in FIGS. 3A-3C is one example of an elastic or spring element that can provide a spring bias for the push bar 410. Other examples include spring bars with different bend arrangements, elastic clips, helical springs, rubber bodies or plugs, and related elastic members. The biasing component 420 does not need to be positioned for contact against the rigid shields 250, 252, 350, and 352 in all cases. The biasing component 420 can also contact other surfaces or regions within the housing 100, including inner surfaces of the housing 100 that are insulated, conductive and electrically coupled to ground, or a combination of insulated and conductive surfaces of the housing 100. Thus, in another embodiment, the housing 100 is a grounded, electrically conductive housing 100, and the biasing component 420 contacts one or more ground surface regions of the housing 100. The biasing component 420 can additionally or alternatively contact other grounding path or shield components that are electrically coupled to ground within the housing 100. The biasing component 420 can also contact insulating (i.e., non-conductive) surfaces of one or more components within the housing 100, such as insulated inner surfaces of the housing 100 itself, the wafer insert 320, and other surfaces within the connector 10.

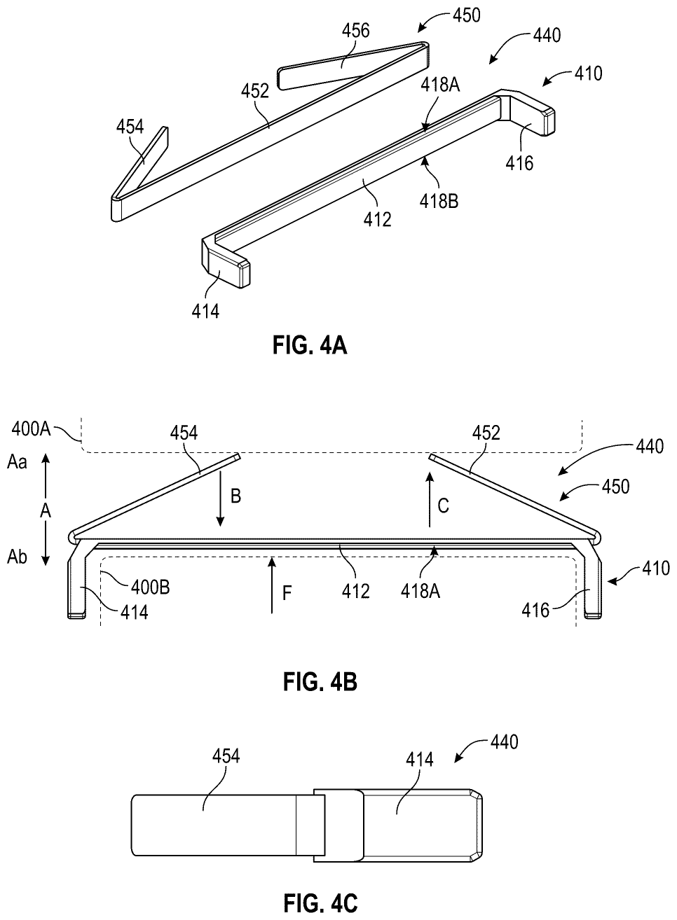

FIG. 4A illustrates another push bar assembly 440 that can be used in the connector 10 shown in FIG. 1A. FIG. 4B illustrates a top view of the push bar assembly 440, and FIG. 4C illustrates a side view of the push bar assembly 440. The biasing component 450 is separated from the push bar 410 in FIG. 4A. The biasing component 450 of the push bar assembly 440 is different than the biasing component 420 of the push bar assembly 400 shown in FIG. 3A. However, the push bar 410 is the same in both the push bar assemblies 400 and 440. The push bar assembly 440 is illustrated as a representative example and is not drawn to any particular scale or size. The shape, size, proportion, and other characteristics of the push bar assembly 440 can vary as compared to that shown. The push bar assembly 440 can be larger, smaller, formed from other materials, and include additional or different components as compared to those shown in FIGS. 4A-4C and described below.

The biasing component 450 can be formed (e.g., stamped, sheared, or otherwise formed) from a flat sheet of metal and bent into the form shown in FIGS. 4A-4C. The push bar 410 can be formed from LCP, PE, PTFE, fluoropolymer, or other plastic or insulating material(s). The biasing component 450 includes single-bend spring fingers 454 and 456 (also “spring fingers 454 and 456”) at opposite ends of a bias bar 452. The push bar 410 can be molded in part around the biasing component 450, or the push bar 410 and biasing component 450 can be secured together in other ways.

FIG. 4B illustrates dashed outlines 401A and 401B. The outline 401A is representative of the front edges of the rigid shields of the wafer assemblies in the connector 10. More particularly the outline 401A is representative of the front edges of the rigid shields 250, 350, and 352 (see FIG. 2D). The outline 401B is representative of the leading end or edge of the paddle card 30 (see FIGS. 1B and 1C). The guide handles 414 and 416 of the push bar 410 can be positioned within datum channels in the sides of the housing 100. Within those datum channels, the push bar 410 can be limited or constrained to motion in the “A” direction only.

Further, as shown in FIG. 4B, the distal ends of the spring fingers 454 and 456 can contact the front edges of the rigid shields 250, 350, and 352, represented by the dashed outline 401A. Being formed from an elastic metal material, the spring fingers 454 and 456 can be compressed in the direction “B” shown in FIG. 4B when a force “F” is provided against the push bar 410. The force “F” can be provided by contact between the leading edge of the paddle card 30 and the push bar 410. In that case, the spring fingers 454 and 456 can be compressed between the rigid shields 250, 350, and 352 and the push bar 410 based on the force “F” applied from the paddle card 30 being inserted into the front end port 102 of the connector 10.

During compression, the push bar 410 will move towards “Aa” in the direction “A.” When the paddle card 30 is removed from the connector 10 and the force “F” is no longer present, then the spring ends 424 and 426 can elastically return back to the form shown in FIG. 4B. The push bar 410 will move back towards “Ab” in the direction “A” in that case. When the push bar 410 moves back towards the position “Ab,” the push bar 410 will contact and push against inner surfaces of the terminal rows 210 and 310, creating a minimal clearance between the opposing contact tips of the terminal rows 210 and 310. The biasing component 450 is another example of an elastic spring component that is capable of providing a spring bias or force for the push bar assembly 440. The embodiments are not limited to using the biasing component 450, however, and other arrangements of coiled springs, elastic bends in metal components, and other elastic and spring components can be relied upon.

FIG. 5A illustrates the sectional view designated A-A of the housing 100 of the connector 10 shown in FIG. 1A, and FIG. 5B illustrates the sectional view designated A-A of the housing 100 and the push bar assembly 440 of the connector 10. As shown in FIG. 5A, the housing 100 includes a datum channel 290 formed in a side region of the housing 100. The datum channel 290 extends toward the front port opening 102. The datum channel 290 is sized to accommodate the guide handle 416 of the push bar 410 with a minimal clearance, as shown in FIG. 5B. The datum channel 290 permits the guide handle 416 to slide within the datum channel 290 and constrains the push bar 410 to movement in only one direction. More particularly, the datum channel 290 permits the guide handle 416 to slide within the datum channel 290 in the direction “A” shown in FIG. 5A. The housing 100 also includes another datum channel formed in a similar location on the other side of the housing 100 for the guide handle 416 of the push bar 410.

FIG. 6 illustrates the sectional view designated B-B of the wafer assemblies shown in FIG. 2A, along with a sectional view of the paddle card 30 inserted into the connector 10. The wafer inserts 220 and 320, rigid shields 252 and 352, flexible shields 242 and 342, and terminal conductors 215 and 315 of the wafer assemblies are shown in FIG. 6. Additionally, the contact bar 412, bias bar 422, and spring end 426 of the push bar assembly 400 are also shown in FIG. 6. The push bar assembly 400 is positioned between the terminal rows 210 and 310. The spring end 426 of the push bar assembly 400 contacts the front edges of the rigid shields 252 and 352. Although not shown in FIG. 6, the spring end 424 (see FIG. 3B) of the push bar assembly 400 also contacts the front edges of the rigid shields 250 and 350 (compare FIG. 2C with FIG. 2D).

The contact tip ends of the terminal conductors 215 and 315, among others in the terminal rows 210 and 310, extend out and away from the wafer inserts 220 and 320, respectively, in a cantilevered arrangement. Without any external forces applied to or mechanical interferences positioned between them, the contact tips of the terminal conductors in the terminal rows 210 and 310 are formed to bend toward and, possibly, contact each other. However, the push bar 410 is positioned between the terminal rows 210 and 310 and maintains a minimal distance or clearance “M” between the opposing contact tips of the terminal conductors 215 and 315, among others in the terminal rows 210 and 310, even when the paddle card 30 is not inserted into the connector. The minimal distance or clearance “M” is maintained by the contact bar 412 of the push bar 410 due to the contact between the inner surfaces of the terminal rows 210 and 310 and the chamfered corner surfaces 418A and 418B at the opposing leading edges of the contact bar 412.

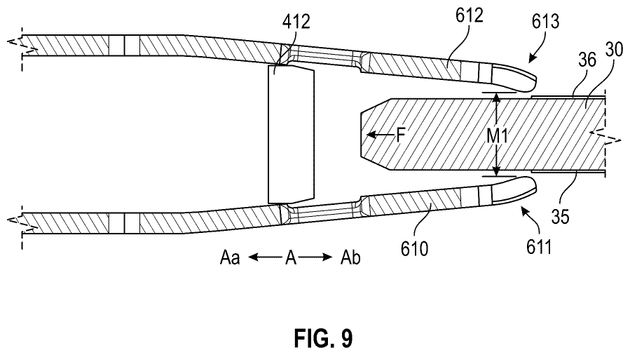

The minimal distance or clearance “M” is identified as an example in FIG. 6 and is not intended to be related to the thickness of the paddle card 30 or other features in FIG. 6. The size of “M” can be determined based on the size, shape, style, and other features of the push bar assembly 400 and the push bar 412, along with the dimensions of the wafer assemblies. As examples, the size or height of the contact bar 412, the size, type, and style of the spring ends 424 and 426 of the push bar assembly 400, and other aspects of the push bar assembly 400 can be tailored to control or determine the minimal distance or clearance “M.” In some cases, the minimal distance or clearance “M” can be selected to be larger than the thickness of the paddle card 30, as described below with reference to FIG. 9.

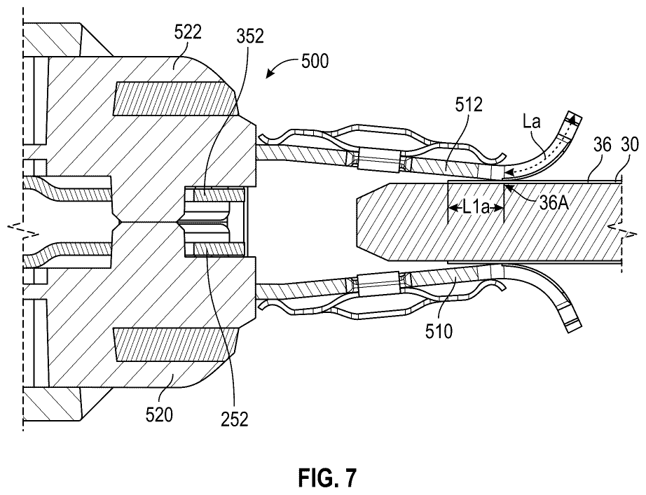

When the paddle card 30 is removed (or absent) from the connector 10, the spring ends 424 and 426 of the push bar assembly 400 are free to push the contact bar 412 towards the position “Ab” in the direction “A.” When the contact bar 412 moves towards the position “Ab,” the contact bar 412 will contact, push, and possibly slide against the inner surfaces of the terminal conductors 215 and 315, among others in the terminal rows 210 and 310. This interference will create the minimal clearance “M” between the opposing contact tips of the terminal rows 210 and 310. The minimal clearance “M” provides a nominal opening for the insertion of the front end of the paddle card 30 between the terminal rows 210 and 310 at the front port opening 102 of the connector 10. Without the minimal clearance “M,” the opposing contact tips of the terminal conductors in the terminal rows 210 and 310 would be relatively closer before insertion of the paddle card 30, leading to a need for the longer contact tips shown in FIG. 7 and described below. The longer contact tips can result in diminished electrical performance, such as increased insertion loss and other unwanted effects. Thus, the length “L” of the contact tip of the terminal conductor 315, among others in the terminal rows 210 and 310, can be reduced according to the concepts described herein. The length “L” can be reduced in part because it is not necessary to use longer, curved contact tips that spread apart from each other when the paddle card 30 is inserted. The shorter contact tips shown in FIG. 6 are sufficient to spread and wipe over the top and bottom surfaces of the paddle card 30.

The mechanical interference provided by the push bar 410 can also be removed or shifted, particularly when the front end of the paddle card 30 is inserted into the connector 10. When the paddle card 30 is inserted into the connector 10, the front end of the paddle card 30 can apply a force “F” against the contact bar 412, pushing the push bar 410 back in the direction of the force “F” and compressing the spring ends 424 and 426 of the push bar assembly 400. During compression, the contact bar 412 will move towards the position “Aa” in the direction “A,” and the terminal conductors 215 and 315, among others in the terminal rows 210 and 310, will no longer rest upon the contact bar 412. The terminal conductors in the terminal rows 210 and 310 will instead spring down upon the top and bottom surfaces of the paddle card 30, making electrical contacts. In the example shown in FIG. 6, the terminal conductor 215 contacts the contact pad 35 at the contact point 35A on the bottom of the paddle card 30, and the terminal conductor 315 contacts the contact pad 36 at the contact point 36A on the top of the paddle card 30. Electrical connections or couplings occur at the contact points 35A and 36A as would be understood in the field.

When the paddle card 30 is inserted into the connector 10, the paddle card 30 may be locked into position based on a locking mechanism between an SFP module including the paddle card 30 and the surrounding cage in which the SFP module is inserted, as would also be understood in the field. While the paddle card 30 is locked into position within the connector 10, contact can be maintained between the front edge of the paddle card 30 and the contact bar 412 of the push bar assembly 400. Further, the contact bar 412 can apply a spring bias force back against the front edge of the paddle card 30, opposing the force “F” shown in FIG. 6. The opposing force against the front edge of the paddle card 30 will close any lash, play, or slop between the SFP module and the locking mechanism with the cage. With the play or slop closed, the position of the contact points 35A and 36A can be more accurately determined and designed for. Thus, the stub length “L1” of the contact pad 36 that extends beyond the contact point 36A can be reduced, because the position of the contact point 36A can be determined more precisely and repeatedly due to the push bar 410. The stub lengths of other contact pads on the paddle card 30 can also be reduced.

The connectors described herein also facilitate methods of drop down contact. According to the example shown in FIG. 6, the method can include maintaining a minimal clearance between the terminal rows 210 and 310 using a mechanical interference. The minimal clearance “M” is maintained by the push bar 410 due to the contact between the inner surfaces of the terminal rows 210 and 310 and the chamfered corner surfaces 418A and 418B at the opposing leading edges of the contact bar 412.

The mechanical interference provided by the push bar 410 can also be removed or shifted when the front end of the paddle card 30 is inserted into the connector 10 as described above, and the method can also include removing the mechanical interference. When the paddle card 30 is inserted into the connector 10, the front end of the paddle card 30 can apply a force “F” against the contact bar 412, pushing the push bar 410 back in the direction of the force “F” and compressing the spring ends 424 and 426 of the push bar assembly 400. During compression, the contact bar 412 will move towards the position “Aa” in the direction “A,” and the terminal conductors in the terminal rows 210 and 310 will no longer rest upon the contact bar 412. The terminal conductors in the terminal rows 210 and 310 will then spring down upon the top and bottom surfaces of the paddle card 30, making electrical contacts. As such, the method can also include dropping down the terminal rows 210 and 310 upon contact pads of a paddle card 30 after removing the mechanical interference.

FIG. 7 illustrates a sectional view of wafer assemblies 500 including terminal conductors with longer contact tips. FIG. 7 illustrates terminal conductors 510 and 512 extending out from wafer inserts 520 and 522, respectively, in a cantilevered arrangement. The example shown in FIG. 7 does not rely upon or incorporate any push bar between terminal rows or the terminal conductors 510 and 512. Without any mechanical interference positioned between them (e.g., without the paddle card 30 or the push bar 410 between them), the contact tips of the terminal conductors 510 and 512 may bend further toward and, possibly, contact each other. Stated simply, the example shown in FIG. 7 does not maintain the minimal distance or clearance “M” shown in FIG. 6. At least in part for that reason, the terminal conductors 510 and 512 in FIG. 7 include longer contact tips than those shown in FIG. 6. For example, the terminal conductor 510 in FIG. 7 includes a longer contact tip of length “La” as compared to the shorter contact tip of length “L” for the terminal conductor 315 shown in FIG. 6. The terminal conductors 510 and 512 in FIG. 7 include longer contact tips to help ensure that the paddle card 30 can appropriately contact, push, and slide the terminal conductors 510 and 512 apart during insertion.

Additionally, without the push bar in FIG. 7, the particular position of the contact point 36A between the terminal conductor 512 and the contact pad 36 may vary over a wider range. When the paddle card 30 is inserted between the terminal conductors 510 and 512, the paddle card 30 may be locked into position based on a locking mechanism, as would be understood in the field. However, an amount of lash, play, or slop between the paddle card 30 and the locking mechanism can be expected. Thus, the exact location of the contact point 36A between the terminal conductor 512 and the contact pad 36 may vary to some extent due to the play or slop. It may be necessary for that reason to design longer contact pads on the paddle card 30, which also results in longer stub lengths. For example, the stub length “L1a” of the contact pad 36 in FIG. 7 is longer than the stub length “L1” of the contact pad 36 in FIG. 6, because the position of the contact point 36A cannot be as precisely set or determined without the push bar 410.

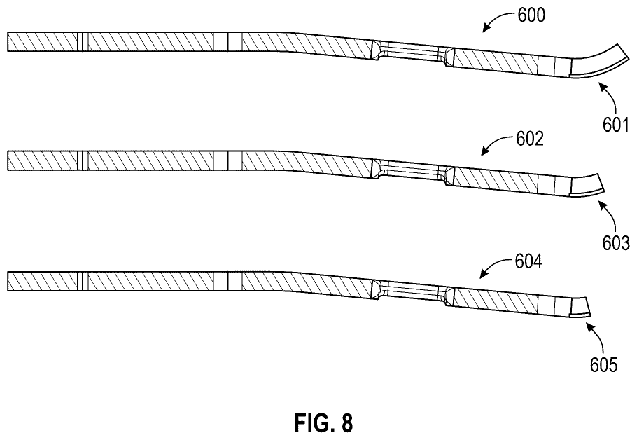

FIG. 8 illustrates examples of other terminal conductors having different contact tip lengths according to various embodiments of the present disclosure. FIG. 8 illustrates three examples of different terminal conductors 600, 602, and 604. The designs of the terminal conductors 600, 602, and 604, among others, can be used in the terminal rows 210 and 310 in the connector 10. The length of the contact tip 601 of the terminal conductor 600 is shorter than the contact tips of the terminal conductors 510 and 512 shown in FIG. 7. Depending on design factors, the concepts described herein can facilitate terminal conductors having even shorter contact tip lengths, however. For example, the length of the contact tip 603 of the terminal conductor 602 is shorter than the contact tip 601 of the terminal conductor 600. Further, the length of the contact tip 605 of the terminal conductor 604 is shorter than the contact tip 603 of the terminal conductor 602. As described above, shorter contact tips can result in reduced insertion loss and other improved electrical characteristics in connectors.

In all the examples shown in FIG. 8, the contact tips 601, 603, and 605 are designed to bend and turn away from the surfaces of the paddle card 30. The examples shown in FIG. 8 may be relied upon with a minimal clearance between contact tips (e.g., such as the minimal clearance “M” shown in FIG. 6) of less than the thickness of the paddle card 30. However, the very small length of the contact tip 605 may require very tight manufacturing tolerances in the connector 10.

According to aspects of the embodiments, connectors including push bars can be designed such that the minimal clearance “M” shown in FIG. 6 is larger (rather than smaller) than the thickness of the paddle card 30. As an example, FIG. 9 illustrates the contact bar 412 of the push bar assembly 400 and terminal conductors 610 and 612 in a design for drop down contact tips. The view in FIG. 9 is similar to that shown in FIG. 6, but the terminal conductors 610 and 612 have drop down contact tips 611 and 613. As depicted, the drop down contact tips 611 and 613 do not bend or curve away from the top and bottom surfaces of the paddle card 30. Further, the contact bar 412 of the push bar assembly 400 is sized and positioned to maintain the minimal clearance “M1” between the contact tips 611 and 613, which is at least minimally larger than the thickness of the paddle card 30.

The paddle card 30 can be inserted between the contact tips 611 and 613 with a small clearance between them in the example shown in FIG. 9. Given the clearance, the contact tips 611 and 613 do not need to bend away from the top and bottom surfaces of the paddle card 30, because the contact tips 611 and 613 do not wipe across the leading corners or top and bottom surfaces of the paddle card 30 as it is inserted. Instead, upon sufficient insertion of the paddle card 30 between the terminals 610 and 612 for the paddle card 30 to contact and push against the contact bar 412 with the force “F,” the push bar 410 will compress and the contact bar 412 will move towards the position “Aa” in the direction “A.” The terminal conductors 610 and 612 will then no longer rest upon the contact bar 412, and the terminal conductors 610 and 612 will drop down upon the paddle card 30, making contact with the contact pads 35 and 36 without (or with less) wiping across the contact pads 35 and 36 during insertion of the paddle card 30.

The concepts and embodiments described herein can also be extended to use with connectors including additional rows of terminal conductors, such as connectors designed for increased data rates with two pairs of terminal rows. FIG. 10 illustrates a perspective view of an example connector 700 according to various embodiments of the present disclosure. The connector 700 is shown to have a length, a width, and a height in the directions shown in FIG. 10. However, the connector 700 is illustrated as a representative example and is not drawn to any particular scale or size. The shape, size, proportion, and other characteristics of the connector 700 can vary as compared to that shown. For example, the connector 700 can accommodate larger or smaller rows of terminals (e.g., be wider or narrower), and other variations are within the scope of the examples described herein. A number of connectors similar to the connector 700 can also be arranged and used together for higher data rate interconnections in some cases. One or more parts or components of the connector 700, as illustrated in the drawings and described below, can be omitted in some cases. The connector 700 can also include other parts or components that are not illustrated or described.

The connector 700 is designed to establish and maintain electrical connections with contacts on a paddle card interface. The connector 700 includes a housing 702 with a front port opening 704. A number of wafer assemblies, rows of terminal conductors, a push bar, and other components are positioned and secured within the housing 702. The paddle card interface of a pluggable module (such as, without limitation, a SFP, OSFP, QSFP, etc. configuration) of a cable assembly can be inserted into the front port opening 704 of the connector 700. The paddle card interface can be embodied as a type of PCB-style interface, as would be understood in the field. Notably, as compared to the connector 10 described above, the connector 700 includes two pairs of terminal rows. Thus, the connector 700 can accommodate paddle cards with additional rows of contact pads.

FIG. 11A illustrates a perspective view of wafer assemblies 710, 720, 730, and 740 in the connector 700 shown in FIG. 10, and FIG. 11B illustrates a side view of the wafer assemblies 710, 720, 730, and 740. The wafer assemblies 710, 720, 730, and 740 of the connector 700 can also be referred to collectively as a wafer assembly of the connector 700. The housing 702 is omitted from view in FIGS. 11A and 11B. The connector 700 includes four wafer assemblies 710, 720, 730, and 740 in the example shown. Referring among FIGS. 11A and 11B, the first wafer assembly 710 includes the wafer insert 712 and the terminal row 714, the second wafer assembly 720 includes the wafer insert 722 and the terminal row 724, the third wafer assembly 730 includes the wafer insert 732 and the terminal row 734, and the fourth wafer assembly includes the wafer insert 742 and the terminal row 744. The shape, size, proportion, and other characteristics of the wafer assemblies 710, 720, 730, and 740 can vary as compared to that shown. For example, the wafer assemblies 710, 720, 730, and 740 can accommodate larger or smaller rows of terminals (e.g., be wider or narrower), and other variations are within the scope of the examples described herein.

The first wafer assembly 710 supports, spaces, and aligns terminal conductors in the terminal row 714. The second wafer assembly 720 supports, spaces, and aligns terminal conductors in the terminal row 724. The third wafer assembly 730 supports, spaces, and aligns terminal conductors in the terminal row 734. The fourth wafer assembly 740 supports, spaces, and aligns terminal conductors in the terminal row 744. The terminal rows 714 and 734 extend out and away from the wafer inserts 712 and 732, respectively, in a cantilevered arrangement.

Each of the terminal rows 714, 724, 734, and 744 includes a row of terminal conductors, including signal conductors, power conductors, and ground conductors. Each of the signal, power, and ground conductors in the terminal rows 714, 724, 734, and 744 includes a tip or lead contact at one distal end, a tail contact at another distal end, and a conductor body that extends between the tip and tail contacts. The signal and power conductors in the terminal rows 714, 724, 734, and 744 are electrically isolated from each other, and electrically isolated from the ground conductors, within the connector 700. The contact tips at the ends of the terminal conductors of the terminal row 714 face the contact tips at the ends of the terminal conductors of the terminal row 744, as best shown in FIG. 11B. Similarly, the contact tips at the ends of the terminal conductors of the terminal row 724 face the contact tips at the ends of the terminal conductors of the terminal row 734, as best shown in FIG. 11B. The arrangement, grouping, spacing, and related characteristics of the signal, ground, and power terminal conductors in the terminal rows 714, 724, 734, and 744 can be the same as that described above for the terminal rows 210 and 310, although variations are within the scope of the embodiments.

A push bar assembly 750 is also illustrated in FIGS. 11A and 11B. The push bar assembly 750 is similar in form and purpose as the push bar assembly 400 described above. However, the push bar assembly 750 has been designed for use with the two pairs of terminal rows 714, 724, 734, and 744 in the connector 700. The push bar assembly 750 includes an insulative or non-conductive push bar 760 and a biasing component 770, as identified in FIG. 11B. The biasing component 770 includes an elastic or spring member that is capable of providing a spring bias or force. The biasing component 770 pushes the push bar 760 toward the front port opening 704 of the connector 700. Based on the force provided from the biasing component 770, the push bar 760 contacts and pushes against inner surfaces of the terminal conductors in the terminal rows 714, 724, 734, and 744. The push bar 760 also maintains the contact tips of the terminal rows 714 and 744 a certain distance apart from each other, particularly when no paddle card is inserted into the front port opening 704 of the connector 700. Additionally, the push bar 760 maintains the contact tips of the terminal rows 724 and 734 a certain distance apart from each other when no paddle card is inserted into the front port opening 704 of the connector 700. The push bar 760 thus provides a predetermined and minimal clearance between the opposing contact tips of the terminal rows 714, 724, 734, and 744.

FIG. 11C illustrates another view of the wafer assemblies of the connector 700 shown in FIG. 10. In FIG. 11C, a subset of the terminals from the terminal row 714 are omitted from view, so that more of the push bar assembly 750 is visible. As described above, the contact tip ends of the terminal conductors in the terminal rows 714, 724, 734, and 744 extend out and away from the wafer inserts 712, 722, 732, and 742, respectively, in a cantilevered arrangement. Without any external forces applied to them, the contact tips of the terminal conductors in the terminal rows 714 and 744 are formed to bend toward and, possibly, contact each other. Similarly, without any external forces applied to them, the contact tips of the terminal conductors in the terminal rows 724 and 734 are formed to bend toward and, possibly, contact each other.

As shown in FIG. 11C, the push bar 760 of the push bar assembly 750 extends in the open spaces between the front terminal rows 714 and 744 and between the back terminal rows 724 and 734. The push bar 760 provides a mechanical interference between the terminal conductors in the terminal rows 714, 724, 734, and 744. Particularly, the biasing component 770 of the push bar assembly 750 pushes the push bar 760 toward the front port opening 704 of the connector 700, and the push bar 760 pushes against inner surfaces of the terminal conductors in the front terminal rows 714 and 744 and the back terminal rows 724 and 734. The inner surfaces of the terminal conductors contact and rest upon the push bar 760 in the arrangement shown in FIG. 11C. The push bar 760 acts as a mechanical interference and maintains a minimal clearance between the opposing contact tips of the terminal rows 714, 724, 734, and 744 consistent with the concepts described herein.

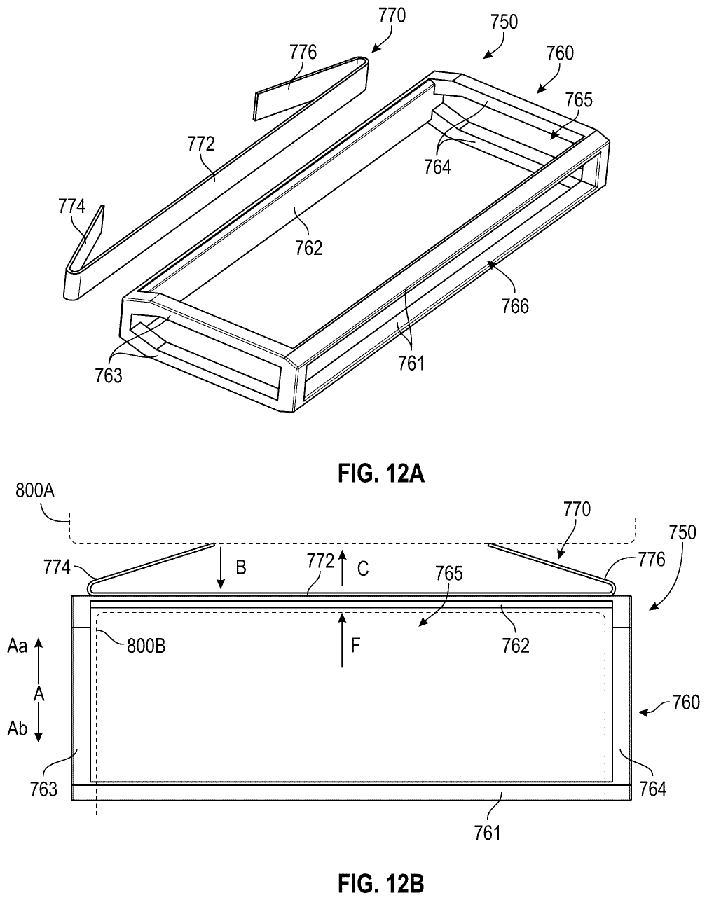

FIGS. 12A and 12B illustrate the push bar assembly 750 of the connector 700 shown in FIG. 10. The biasing component 770 is separated from the push bar 760 in FIG. 12A. FIG. 12B illustrates a top view of the push bar assembly 750. The push bar assembly 750 is illustrated as a representative example and is not drawn to any particular scale or size. The shape, size, proportion, and other characteristics of the push bar assembly 750, push bar 760, and biasing component 770 can vary as compared to that shown. The push bar assembly 750 can be larger, smaller, formed from other materials, and include additional or different components as compared to those shown and described below.

The biasing component 770 can be formed (e.g., stamped, sheared, or otherwise formed) from a flat sheet of metal and bent into the form shown in FIGS. 12A and 12B. The push bar 760 can be formed from LCP, PE, PTFE, fluoropolymer, or other plastic or insulating material(s). The push bar 760 includes a leading bumper bar 761, a trailing bumper bar 762, and guide carriages 763 and 764 at opposite ends of the bumper bars 761 and 762. The push bar 760 also includes a terminal window 765 between the bumper bars 761 and 762 and the guide carriages 763 and 764. The terminal window 765 is an opening or aperture that extends between the bumper bars 761 and 762 and the guide carriages 763 and 764. The push bar 760 also includes a paddle card window 766 within the leading bumper bar 761. A paddle card can be inserted through the paddle card window 766, after it is inserted into the front port opening 704 of the connector 700. The leading bumper bar 761 and the trailing bumper bar 762 can include chamfered or rounded corner surfaces. The biasing component 770 includes single-bend spring fingers 774 and 776 (also “spring fingers 774 and 776”) at opposite ends of a bias bar 772. The push bar 760 can be molded in part around the biasing component 770, or the push bar 760 and biasing component 770 can be secured together in other ways.

FIG. 12B illustrates dashed outlines 800A and 800B. The outline 800A is representative of the front edges or surfaces of the wafer inserts 722 and 732 of the wafer assemblies 720 and 730 in the connector 700. The outline 800B is representative of a paddle card, similar to the paddle card 30 shown in FIGS. 1B and 1C. The guide carriages 763 and 764 of the push bar 760 can be positioned within datum channels in the sides of the housing 702 when the connector 700 is assembled. Within those datum channels, the push bar 760 is limited or constrained to motion in the “A” direction only.

Further, as shown in FIG. 12B, the ends of the spring fingers 774 and 776 can contact the front edges or surfaces of the wafer inserts 722 and 732, represented by the dashed outline 800A. The wafer inserts 722 and 732 act as a type of anchor or foundation against which the spring fingers 774 and 776 can push and spring against. Being formed from an elastic metal material, the spring fingers 774 and 776 can be compressed in the direction “B” shown in FIG. 12B between the trailing bumper bar 762 and the wafer inserts 722 and 732. The spring fingers 774 and 776 can be compressed when a force “F” is provided against the trailing bumper bar 762. The force “F” can be provided by contact between the leading edge of a paddle card, such as the paddle card 30, which can be inserted into the front port opening 704 of the connector 700 and through the paddle card window 766 of the push bar 760. Based on the force “F,” the spring fingers 774 and 776 can be compressed between the wafer inserts 722 and 732 and the trailing bumper bar 762 based on the force “F” applied from the paddle card being inserted into the front end port 704 of the connector 700.

During compression, the push bar 760 will move towards “Aa” in the direction “A.” Referring back to FIG. 11C, when the push bar 760 moves towards “Aa” in the direction “A,” the leading bumper bar 761 and the trailing bumper bar 762 will move back and away from the position of mechanical interference between the terminal rows 714, 724, 734, and 744. The terminal rows 714, 724, 734, and 744 will then be free to move. Without any external forces or interferences between them, the contact tips of the terminal conductors in the terminal rows 714 and 744 can move toward each other. Similarly, without any external forces or interferences between them, the contact tips of the terminal conductors in the terminal rows 724 and 734 can move toward each other. Although not shown in FIG. 11C, the contact tips of the terminal conductors in the terminal rows 714, 724, 734, and 744 can contact the contact pads on the paddle card inserted within the connector 700, consistent with the concepts described herein.

When the paddle card is removed from the connector 700 and the force “F” is no longer present, then the spring fingers 774 and 776 of the biasing component 770 can elastically return back to the form shown in FIG. 12B. In that case, the spring fingers 774 and 776 of the biasing component 770 can expand against the contact with the wafer inserts 722 and 732. The push bar 760 will move back towards “Ab” in the direction “A” in that case. When the push bar 760 moves back towards the position “Ab,” the push bar 760 will contact and push against inner surfaces of the terminal rows 714, 724, 734, and 744, creating a minimal clearance between the opposing contact tips of the terminal rows 714, 724, 734, and 744 as shown in FIG. 11B and according to the concepts described herein. The biasing component 770 is one example of an elastic spring component that is capable of providing a spring bias or force for the push bar assembly 750. The embodiments are not limited to using the biasing component 770, however, and other arrangements of coiled springs, elastic bends in metal components, and other elastic and spring components can be relied upon.

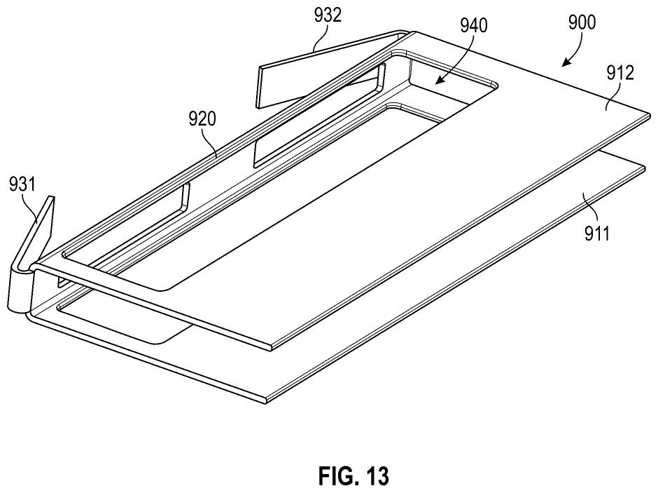

FIG. 13 illustrates another example push bar assembly 900 that can be relied upon in the connector 700 shown in FIG. 10 according to various embodiments of the present disclosure. The push bar assembly 900 is similar in purpose to the push bar assembly 750 described above. Like the push bar assembly 750, the push bar assembly 900 is designed for use with two pairs of terminal rows, such as the two pairs of terminal rows 714, 724, 734, and 744 in the connector 700. The push bar assembly 900 is illustrated as a representative example and is not drawn to any particular scale or size. The shape, size, proportion, and other characteristics of the push bar assembly 900 can vary as compared to that shown. The push bar assembly 900 can be larger, smaller, formed from other materials, and include additional or different components as compared to those shown and described below.

The push bar assembly 900 is formed as a single component in the example shown. The push bar assembly 900 can be formed (e.g., stamped, sheared, or otherwise formed) from a flat sheet of metal and bent into the form shown in FIG. 13. In that case, the push bar assembly 900 can be covered or coated with an insulating material, such as a plastic, laminate coating, or related dielectric insulator. The push bar assembly 900 can also be molded or otherwise formed using additive or subtractive manufacturing techniques from LCP, PE, PTFE, fluoropolymer, or other plastic or insulating material(s).

The push bar assembly 900 includes a lower bumper bar 911, an upper bumper bar 912, and a trailing bumper bar 920. The push bar assembly 900 also includes a terminal window 940 between the lower bumper bar 911 and the upper bumper bar 912. A paddle card can be inserted between the lower bumper bar 911 and the upper bumper bar 912. The push bar assembly 900 also includes single-bend spring fingers 931 and 932 at opposite ends of the trailing bumper bar 920.

As noted above, the push bar assembly 900 is similar in purpose to the push bar assembly 750 and can be used in place of the push bar assembly 750 in the connector 700. If used in the connector 700, the push bar assembly 900 can provide a mechanical interference between the terminal conductors in the terminal rows 714, 724, 734, and 744. Particularly, the spring fingers 931 and 932 of the push bar assembly 900 can push the push bar assembly 900 toward the front port opening 704 of the connector 700, and the push bar assembly 900 can contact inner surfaces of the terminal conductors in the front terminal rows 714 and 744 and the back terminal rows 724 and 734. The inner surfaces of the terminal conductors in the front terminal rows 714 and 744 can rest upon the front edges of the lower bumper bar 911 and the upper bumper bar 912. The inner surfaces of the terminal conductors in the back terminal rows 724 and 734 can extend in part within the window 940 and rest upon the edges of the trailing bumper bar 920. The push bar assembly 900 can thus act as a mechanical interference and maintains a minimal clearance between the opposing contact tips of the terminal rows 714, 724, 734, and 744 consistent with the concepts described herein.

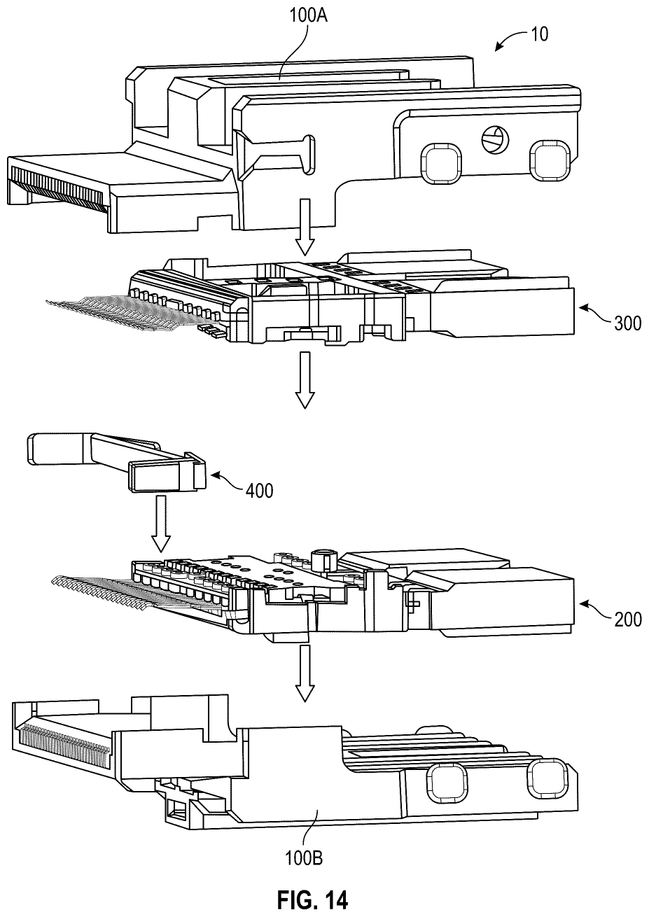

FIG. 14 illustrates an example assembly approach for connectors according to various embodiments of the present disclosure. Assembly of the connector 10 shown in FIG. 1A is described as an example with reference to FIG. 14, but other types of connectors including the drop down contact concepts described herein can also be assembled in a similar way. The housing 100 of the connector 10 is split into an upper half 100A and a lower half 100B. The wafer assemblies 200 and 300 are separately manufactured and assembled. The push bar assembly 400 is also separately manufactured and assembled, as needed.

To assemble the connector 10, the lower wafer assembly 200 can be inserted down and into the lower half 100B of the housing 100. Next, the push bar assembly 400 can be positioned and inserted over the lower wafer assembly 200. Then, the upper wafer assembly 300 can be positioned and inserted over the push bar assembly 400 and the lower wafer assembly 200. Finally, the upper half 100A of the housing 100 can be positioned and placed over the wafer assemblies 200 and 300, with the push bar assembly 400 being positioned between the wafer assemblies 200 and 300. The assembly approach illustrated in FIG. 14 can be helpful to position the push bar assembly 400 between the terminal rows of the wafer assemblies 200 and 300. The connectors 10B and 10C, which are described below, can also be assembled using the approach shown in FIG. 14.

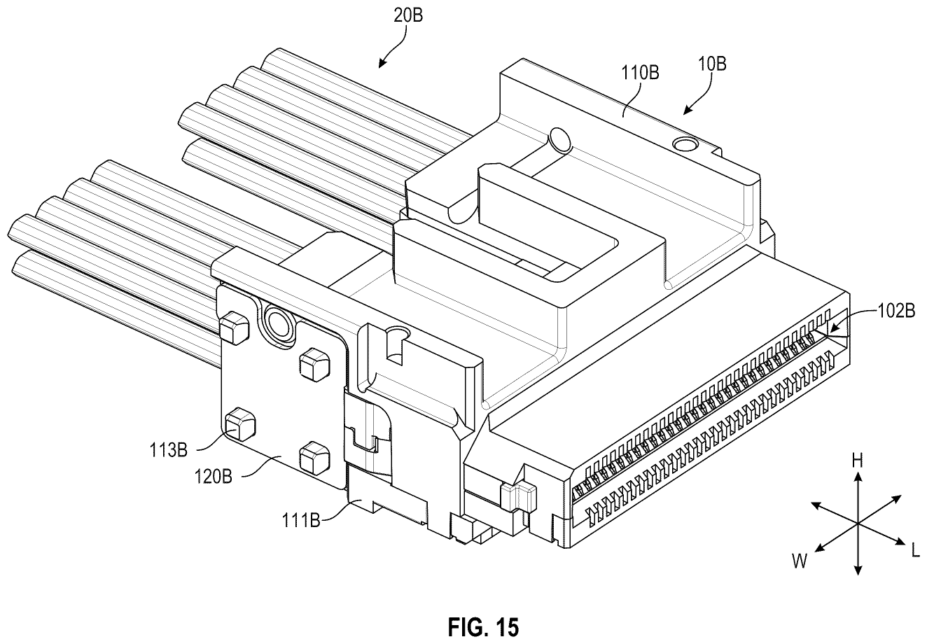

FIG. 15 illustrates a perspective view of another example connector 10B according to the drop down contact concepts described herein. The connector 10B is shown to have a length, a width, and a height in the directions shown in FIG. 15. However, the connector 10B is illustrated as a representative example and is not drawn to any particular scale or size. The shape, size, proportion, and other characteristics of the connector 10B can vary as compared to that shown. The connector 10B can accommodate larger or smaller rows of terminals (e.g., be wider or narrower), and other variations are within the scope of the examples described herein. One or more parts or components of the connector 10B, as illustrated in the drawings and described below, can be omitted in some cases. The connector 10B can also include other parts or components that are not illustrated or described.

Similar to the other connectors described herein, the connector 10B is designed to establish and maintain electrical connections with contacts on a paddle card interface. The connector 10B includes a housing formed in two parts, with an upper housing 110B and lower housing 111B. The housing includes a front port opening 102B. A number of wafer assemblies, rows of terminal conductors, a push bar, and other components are positioned and secured within the housing. The upper housing 110B and the lower housing 111B can be formed from a plastic, such as LCP, PE, PTFE, fluoropolymer, or other plastic or insulating material(s). The housing can also be formed, in whole or in part, from conductive materials including metal(s), and the housing can also be formed from combinations of insulating and conductive materials in some cases. In some cases, certain surfaces or surface areas of the housing can be plated with a plating metal or metals for conductivity, and the housing can be embodied as a plated plastic component in some cases.

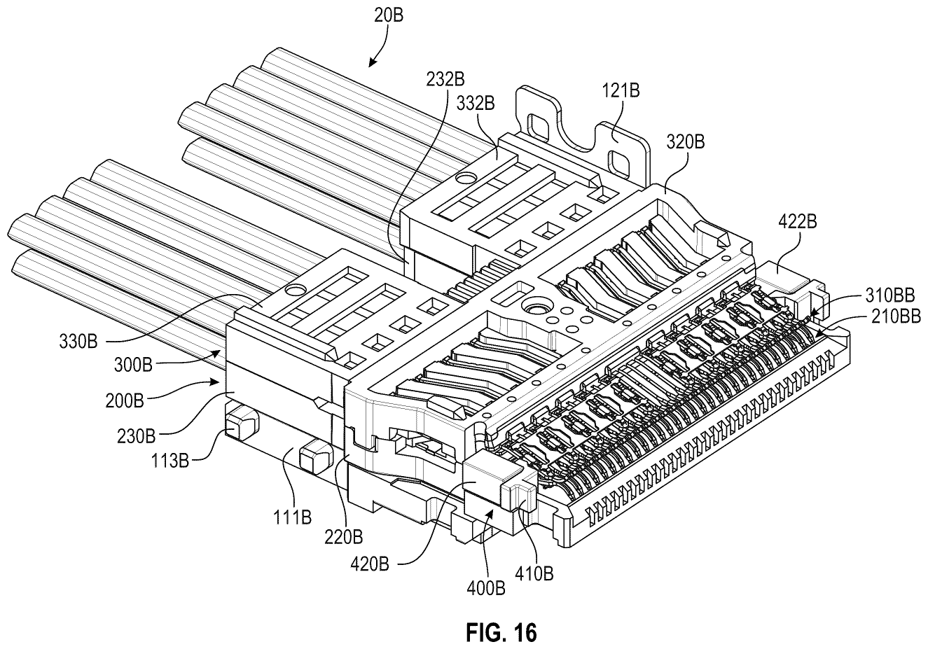

The connector 10B includes side plates 120B and 121B (see FIG. 16), which can be formed from metal or another rigid material, in the example shown. The side plates 120B and 121B include openings or apertures. Projecting posts are formed in the sides of the upper housing 110B and lower housing 111B, and the projecting posts extend through the apertures of the side plates 120B and 121B. For example, the projecting post 113B is formed in the side of the lower housing 111B, and the projecting post 113B extends through an aperture in the side plate 120B as shown in FIG. 15. The side plates 120B and 121B can be relied upon to help secure the upper and lower housings 110B and 111B together in that arrangement. In some cases, the projecting posts can be heat staked after assembly of the connector 10B. In that case, the ends of the projecting posts would be heated and flattened (e.g., compressed down) over the exterior faces or surfaces of the side plates 120B and 121B.

A cable bundle 20B extends to the back of the connector 10B. The cable bundle 20B can be similar to the cable bundle 20 described above and includes a number of cables with signal conductors and ground or drain conductors. The signal and ground conductors in the cable bundle 20B are electrically terminated to signal and ground terminal conductors within the connector 10B. The terminal conductors in the connector 10B extend from the front port opening 102B to the cables in the cable bundle 20B.

Terminal rows are positioned and secured within the connector 10B. The opposing contact tips of the terminal rows are maintained a certain distance apart from each other, even when no paddle card is present in the front port opening 102B. Similar to the other examples described herein, a push bar is positioned between first and second rows of terminal conductors in the connector 10B. The push bar maintains the opposing contact tips of the rows of terminal conductors a certain distance apart from each other, even when no paddle card is present in the front port opening 102B. These and other aspects of the connector 10B are described below.

FIG. 16 illustrates a perspective view of wafer assemblies 200B and 300B of the connector 10B shown in FIG. 15. The upper housing 110B is omitted from view in FIG. 16, so that the wafer assemblies 200B and 300B are visible. The wafer assemblies 200B and 300B can also be referred to collectively as a wafer assembly of the connector 10B. The first wafer assembly 200B includes the terminal row 210BB, the wafer insert 220B, and cable inserts 230B and 232B. The second wafer assembly 300B includes the terminal row 310BB, the wafer insert 320B, and cable inserts 330B and 332B. The wafer assemblies 200B and 300B are illustrated as representative examples and are not drawn to any particular scale or size. The shape, size, proportion, and other characteristics of the wafer assemblies 200B and 300B can vary as compared to that shown.

Each of the terminal rows 210BB and 310BB includes a row of terminal conductors, including signal conductors, power conductors, and ground conductors. Each of the signal, power, and ground conductors in the terminal rows 210BB and 310BB includes a tip or lead contact at one distal end (i.e., positioned within the front port opening 102B of the connector 10B), a tail contact at another distal end, and a conductor body that extends between the tip and tail contacts. The signal and power conductors in the terminal rows 210BB and 310BB are electrically isolated from each other, and electrically isolated from the ground conductors, within the connector 10B. Each of the signal conductors in the terminal rows 210BB and 310BB extends from a tip or lead contact at the front port opening 102B to a signal conductor in one of the cables in the cable bundle 20B. The ground conductors in the terminal rows 210BB and 310BB extend from the contact tips at the front port opening 102B to a ground path assembly.

FIG. 16 also illustrates a push bar assembly 400B positioned between the terminal rows 210BB and 310BB. The push bar assembly 400B includes a push bar 410B and elastic blocks or members 420B and 422B, which serve as biasing components for the push bar 410B. The elastic blocks 420B and 422B are shaped as rectangular cuboids in the example shown, but the elastic blocks 420B and 422B can also be shaped as square cuboids, cylinders, or other shapes in other embodiments. The elastic blocks 420B and 422B can be formed of an elastic, elastomeric, or related material, such as rubber, silicone rubber, an elastic foam, or other material capable of elastic deformation and providing an elastic or spring bias.

The elastic blocks 420B and 422B push the push bar 410B toward the front port opening 102B of the connector 10B. Based on the force provided by the elastic blocks 420B and 422B, the push bar 410B contacts and pushes against inner surfaces of the terminal conductors in the terminal rows 210BB and 310BB. The push bar 410B also maintains the contact tips of the terminal rows 210BB and 310BB a certain distance apart from each other, particularly when no paddle card is inserted into the front port opening 102B of the connector 10B. Consistent with the concepts described herein, the push bar 410B provides a predetermined and minimal clearance between the opposing contact tips of the terminal rows 210BB and 310BB.

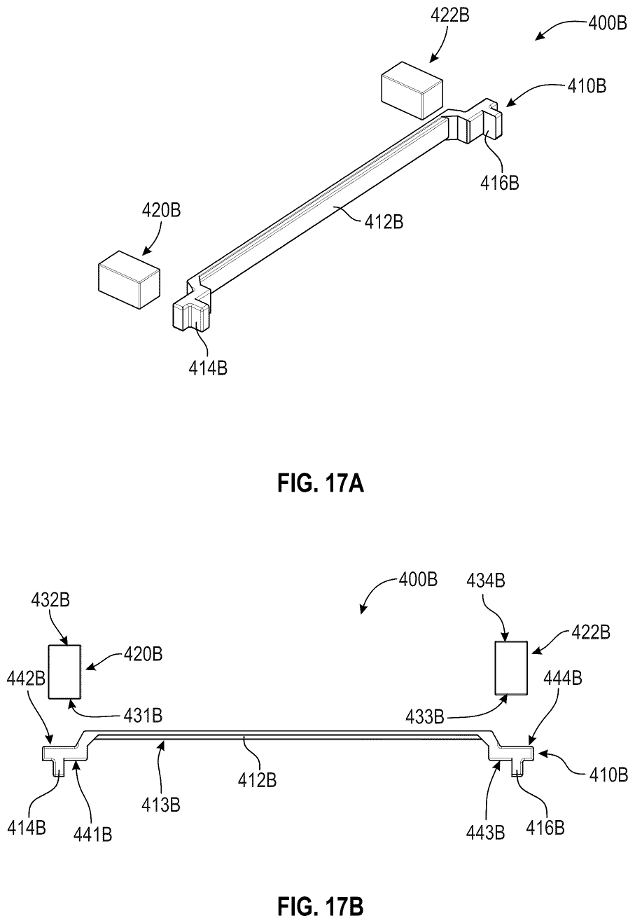

FIG. 17A illustrates a perspective view of the push bar assembly 400B of the connector 10B shown in FIG. 15, and FIG. 17B illustrates a top view of the push bar assembly 400B. The push bar assembly 400B is illustrated as a representative example and is not drawn to any particular scale or size. The shape, size, proportion, and other characteristics of the push bar assembly 400B, the push bar 410B, and the elastic blocks 420B and 422B can vary as compared to that shown. The push bar assembly 400B can be larger, smaller, formed from other materials, and include additional or different components as compared to those shown in FIGS. 17A and 17B and described below.

The push bar assembly 400B includes the push bar 410B and the elastic blocks 420B and 422B. The elastic blocks 420B and 422B are separated from the push bar 410B in FIGS. 17A and 17B. The push bar 410B can be formed from LCP, PE, PTFE, fluoropolymer, cured epoxy, hard rubber, or other insulating material(s). The push bar 410B includes guide tabs 414B and 416B at opposite ends of a contact bar 412B. The elastic blocks 420B and 422B can be formed from an elastic material, such as rubber, an elastic foam, or other material capable of providing an elastic or spring bias. In some cases, the elastic blocks 420B and 422B can be embodied as springs, elastic clips, or other elastic materials or components. If desired, the elastic blocks can be adhered to the push bar or the supporting housing to help ensure the elastic blocks are in the appropriate location.

Referring to FIG. 17B, the push bar 410B includes a front surface 413B. The push bar 410B also includes a front bump surface 441B and a rear bump surface 442B, at one side of the push bar 410B, and a front bump surface 443B and a rear bump surface 444B, at another side of the push bar 410B. The guide tabs 414B and 416B extend out from the front bump surfaces 441B and 443B, respectively. The front bump surfaces 441B and 443B extend in a first plane, the rear bump surfaces 442B and 444B extend in a second plane, and the front surface 413B of the contact bar 412B extends in a third plane. The first, second, and third planes extend parallel to each other in the example shown. The elastic block 420B includes a front face or surface 431B and a back face or surface 432B. The elastic block 422B includes a front face or surface 433B and a back face or surface 434B.

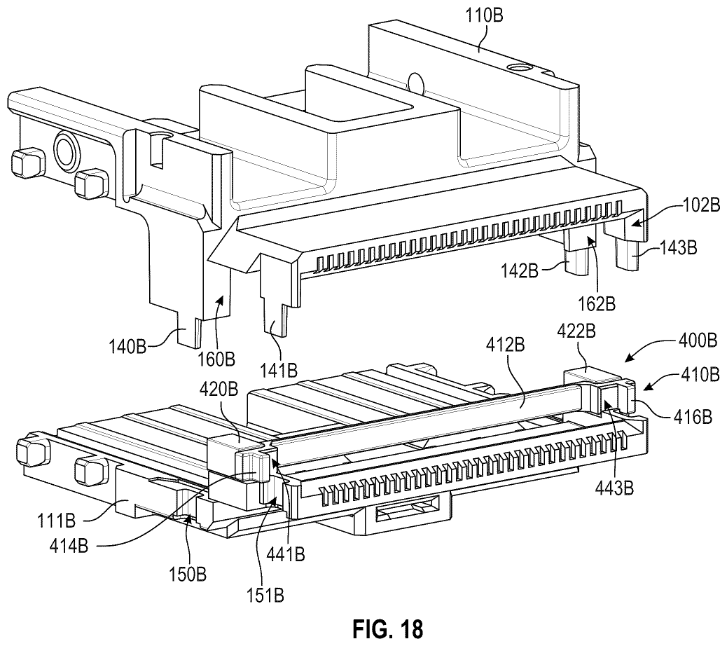

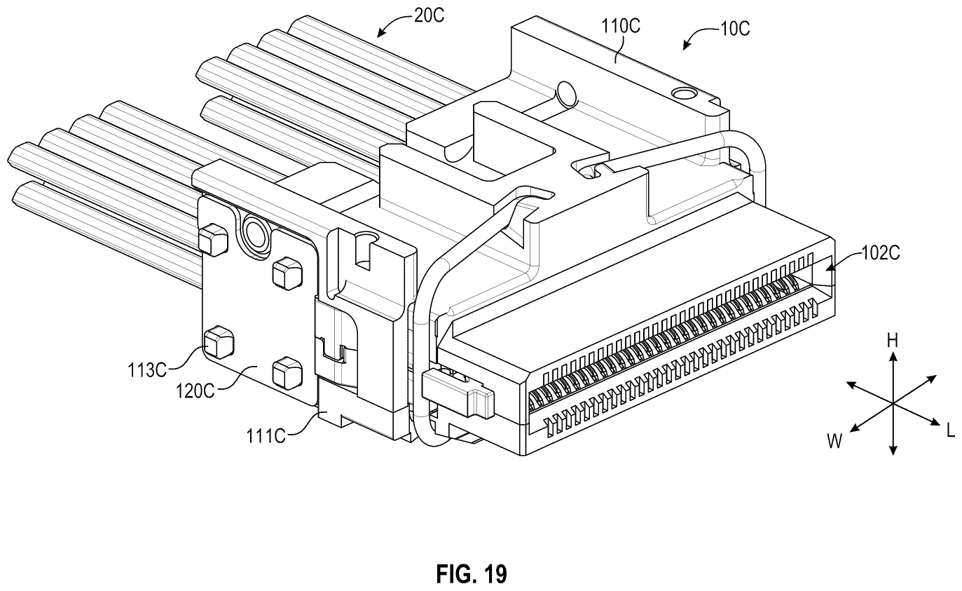

FIG. 18 illustrates a perspective view of the upper housing 110B, the lower housing 111B, and the push bar assembly 400B of the connector 10B shown in FIG. 15. In the connector 10B, the push bar 410B is biased forward by the elastic blocks 420B and 422B against surfaces of the upper housing 110B. The elastic blocks 420B and 422B are positioned between surfaces of the upper housing 110B and the push bar 410B. When the connector 10B is assembled, the elastic block 420B is positioned between the side surface 160B of the upper housing 110B and the rear bump surface 442B (see FIG. 17B) of the push bar 410B. In that arrangement, the front face 431B (see FIG. 17B) of the elastic block 420B contacts the rear bump surface 442B (see FIG. 17B) of the push bar 410B, and the rear face 432B of the elastic block 420B contacts the side surface 160B (see FIG. 18) of the upper housing 110B. Additionally, the elastic block 422B is positioned between the side surface 162B of the upper housing 110B and the rear bump surface 444B (see FIG. 17B) of the push bar 410B. In that arrangement, the front face 433B (see FIG. 17B) of the elastic block 422B contacts the rear bump surface 444B (see FIG. 17B) of the push bar 410B, and the rear face 434B of the elastic block 422B contacts the side surface 162B (see FIG. 18) of the upper housing 110B.

The upper housing 110B and the lower housing 111B also include interlocking features. For example, the lower housing 111B includes channels 150B and 151B at one side and corresponding channels (not shown) at the other side of the lower housing 111B. The upper housing 110B includes alignment posts 140B and 141B at one side and alignment posts 142B and 143B at the other side of the upper housing 110B. When the connector 10B is assembled, the alignment posts 140B and 141B of the upper housing 110B extend into the channels 150B and 151B of the lower housing 111B. The alignment posts 142B and 143B of the upper housing 110B also extend into corresponding channels of the lower housing 111B. The alignment posts and channels in the upper and lower housings 110B and 111B help to position and secure the housing of the connector 10B together. The alignment posts and channels can be formed in other positions on the upper and lower housings 110B and 111B, reversed in locations between the upper and lower housings 110B and 111B, and also varied in size, shape, and other characteristics in other cases. The alignment posts described above, among others, can also be heat staked into the corresponding and mating channels, to help secure the upper and lower housings 110B and 111B together.

When the connector 10B is assembled, the elastic blocks 420B and 422B push the push bar 410B forward and into contact with the upper housing 110B. The elastic blocks 420B and 422B urge the push bar 410B forward such that the front bump surfaces 441B and 443B of the push bar 410B contact the rear edges of the alignment posts 141B and 143B of the upper housing 110B, respectively. In that position, the guide tabs 414B and 416B are positioned beside (and outside of) the alignment posts 140B and 141B of the upper housing 110B. The push bar 410B also contacts and pushes against inner surfaces of the terminal conductors in the terminal rows 210BB and 310BB. The push bar 410B maintains the contact tips of the terminal rows 210BB and 310BB a certain distance apart from each other in that configuration.

When a paddle card is inserted into the front port opening 102B of the connector 10B, the front edge of the paddle card will contact and push against the contact bar 412B. In turn, the push bar 410B will compress the elastic blocks 420B and 422B against the side surfaces 160B and 162B of the upper housing 110B, and the push bar 410B will move deeper into the front port opening 102B. The push bar 410B will no longer contact the inner surfaces of the terminal conductors in the terminal rows 210BB and 310BB, and the tips of the terminal conductors will drop down according to the concepts described herein.

FIG. 19 illustrates a perspective view of another example connector 10C according to the drop down contact concepts described herein. The connector 10C is shown to have a length, a width, and a height in the directions shown in FIG. 19. However, the connector 10C is illustrated as a representative example and is not drawn to any particular scale or size. The shape, size, proportion, and other characteristics of the connector 10C can vary as compared to that shown. The connector 10C can accommodate larger or smaller rows of terminals (e.g., be wider or narrower), and other variations are within the scope of the examples described herein. One or more parts or components of the connector 10C, as illustrated in the drawings and described below, can be omitted in some cases. The connector 10C can also include other parts or components that are not illustrated or described.

Similar to the other connectors described herein, the connector 10C is designed to establish and maintain electrical connections with contacts on a paddle card interface. The connector 10C includes a housing formed in two parts, with an upper housing 110C and lower housing 111C. The housing includes a front port opening 102C. A number of wafer assemblies, rows of terminal conductors, a push bar, and other components are positioned and secured within the housing. The upper housing 110C and the lower housing 111C can be formed from a plastic, such as LCP, PE, PTFE, fluoropolymer, or other plastic or insulating material(s). The housing can also be formed, in whole or in part, from conductive materials including metal(s), and the housing can also be formed from combinations of insulating and conductive materials in some cases. In some cases, certain surfaces or surface areas of the housing can be plated with a plating metal or metals for conductivity, and the housing can be embodied as a plated plastic component in some cases.

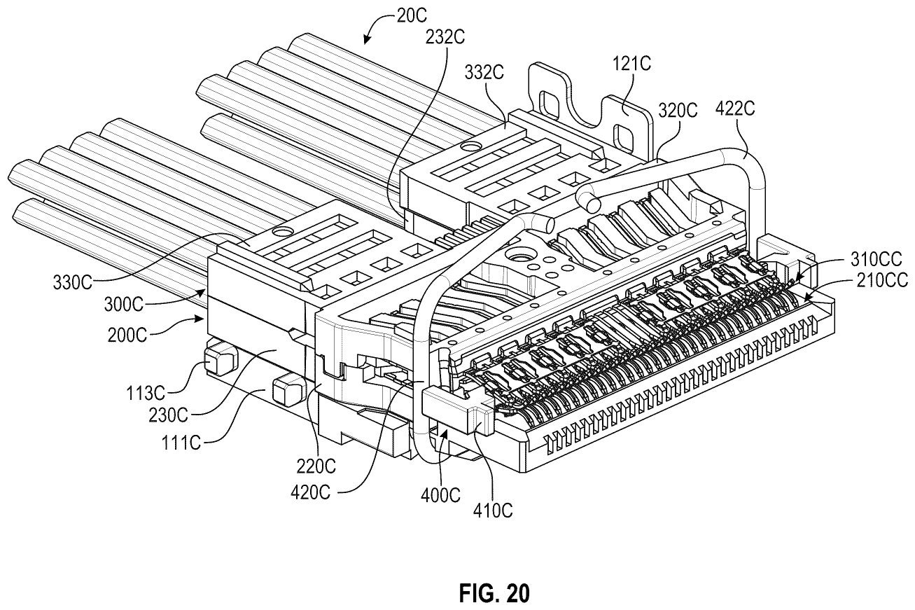

The connector 10C includes side plates 120C and 121C (see FIG. 20), which can be formed from metal or another rigid material, in the example shown. The side plates 120C and 121C include openings or apertures. Projecting posts are formed in the sides of the upper housing 110C and lower housing 111C, and the projecting posts extend through the apertures of the side plates 120C and 121C. For example, the projecting post 113C is formed in the side of the lower housing 111C, and the projecting post 113C extends through an aperture in the side plate 120C as shown in FIG. 19. The side plates 120C and 121C can be relied upon to help secure the upper and lower housings 110C and 111C together in that arrangement. In some cases, the projecting posts can be heat staked after assembly of the connector 10C. In that case, the ends of the projecting posts would be heated and flattened (e.g., compressed down) over the exterior faces or surfaces of the side plates 120C and 121C. Side plates similar to those shown in FIGS. 19 and 20 can be implemented in any of the embodiments described herein.

A cable bundle 20C extends to the back of the connector 10C. The cable bundle 20C can be similar to the cable bundle 20 described above and includes a number of cables with signal conductors and ground or drain conductors. The signal and ground conductors in the cable bundle 20C are electrically terminated to signal and ground terminal conductors within the connector 10C. The terminal conductors in the connector 10C extend from the front port opening 102C to the cables in the cable bundle 20C.

Terminal rows are positioned and secured within the connector 10C. The opposing contact tips of the terminal rows are maintained a certain distance apart from each other, even when no paddle card is present in the front port opening 102C. Similar to the other examples described herein, a push bar is positioned between first and second rows of terminal conductors in the connector 10C. The push bar maintains the opposing contact tips of the rows of terminal conductors a certain distance apart from each other, even when no paddle card is present in the front port opening 102C. These and other aspects of the connector 10C are described below.

FIG. 20 illustrates a perspective view of wafer assemblies 200C and 300C of the connector 10C shown in FIG. 19. The upper housing 110C is omitted from view in FIG. 20, so that the wafer assemblies 200C and 300C are visible. The wafer assemblies 200C and 300C can also be referred to collectively as a wafer assembly of the connector 10C. The first wafer assembly 200C includes the terminal row 210CC, the wafer insert 220C, and cable inserts 230C and 232C. The second wafer assembly 300C includes the terminal row 310CC, the wafer insert 320C, and cable inserts 330C and 332C. The wafer assemblies 200C and 300C are illustrated as representative examples and are not drawn to any particular scale or size. The shape, size, proportion, and other characteristics of the wafer assemblies 200C and 300C can vary as compared to that shown.

Each of the terminal rows 210CC and 310CC includes a row of terminal conductors, including signal conductors, power conductors, and ground conductors. Each of the signal, power, and ground conductors in the terminal rows 210CC and 310CC includes a tip or lead contact at one distal end (i.e., positioned within the front port opening 102C of the connector 10C), a tail contact at another distal end, and a conductor body that extends between the tip and tail contacts. The signal and power conductors in the terminal rows 210CC and 310CC are electrically isolated from each other, and electrically isolated from the ground conductors, within the connector 10C. Each of the signal conductors in the terminal rows 210CC and 310CC extends from a tip or lead contact at the front port opening 102C to a signal conductor in one of the cables in the cable bundle 20C. The ground conductors in the terminal rows 210CC and 310CC extend from the contact tips at the front port opening 102C to a ground path assembly.

FIG. 20 also illustrates a push bar assembly 400C positioned between the terminal rows 210CC and 310CC. The push bar assembly 400C includes a push bar 410C and elastic clips 420C and 422C, which serve as biasing components for the push bar 410C. The elastic clips 420C and 422C are shaped as “C” clips in the example shown, and the elastic clips 420C and 422C can also be formed to other shapes in other embodiments. The elastic clips 420C and 422C can be formed of an elastic material as described below.

The elastic clips 420C and 422C push the push bar 410C toward the front port opening 102C of the connector 10C. Based on the force provided by the elastic clips 420C and 422C, the push bar 410C contacts and pushes against inner surfaces of the terminal conductors in the terminal rows 210CC and 310CC. The push bar 410C also maintains the contact tips of the terminal rows 210CC and 310CC a certain distance apart from each other, particularly when no paddle card is inserted into the front port opening 102C of the connector 10C. Consistent with the concepts described herein, the push bar 410C provides a predetermined and minimal clearance between the opposing contact tips of the terminal rows 210CC and 310CC.

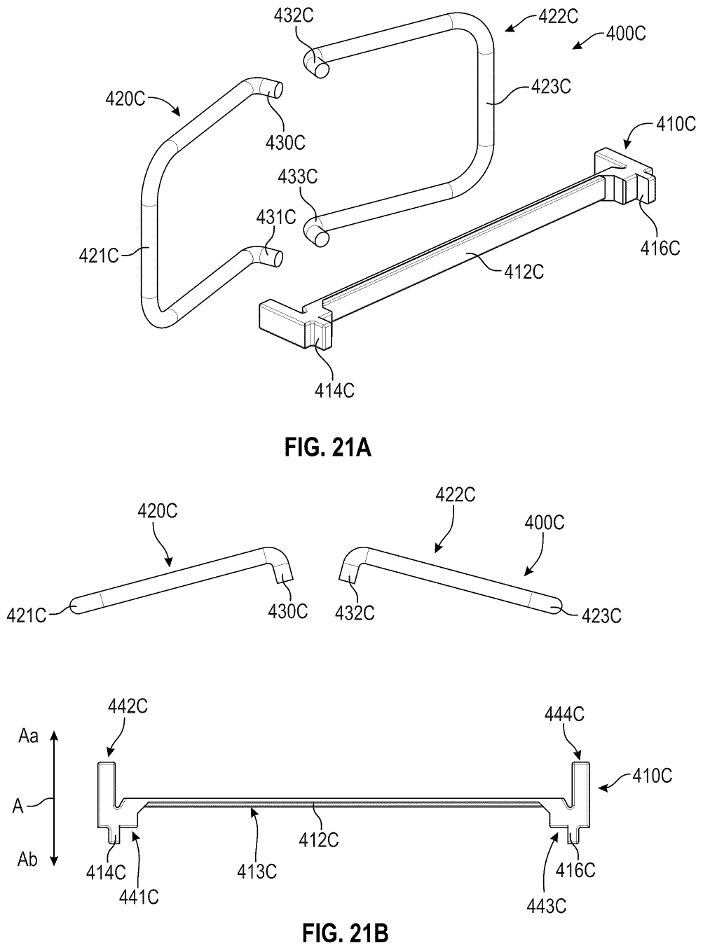

FIG. 21A illustrates a perspective view of the push bar assembly 400C of the connector 10C shown in FIG. 19, and FIG. 21B illustrates a top view of the push bar assembly 400C. The push bar assembly 400C is illustrated as a representative example and is not drawn to any particular scale or size. The shape, size, proportion, and other characteristics of the push bar assembly 400C, the push bar 410C, and the elastic clips 420C and 422C can vary as compared to that shown. The push bar assembly 400C can be larger, smaller, formed from other materials, and include additional or different components as compared to those shown in FIGS. 21A and 21B and described below.

The push bar assembly 400C includes the push bar 410C and the elastic clips 420C and 422C. The elastic clips 420C and 422C are separated from the push bar 410C in FIGS. 21A and 21B. The push bar 410C can be formed from LCP, PE, PTFE, fluoropolymer, cured epoxy, hard rubber, or other insulating material(s). The push bar 410C includes guide tabs 414C and 416C at opposite ends of a contact bar 412C. The elastic clips 420C and 422C can be formed from an elastic material, such as metal, plastic, or another suitable material capable of providing an elastic or spring bias.

Referring to FIG. 21B, the push bar 410C includes a front surface 413C. The push bar 410C also includes a front bump surface 441C and a rear bump surface 442C, at one side of the push bar 410C, and a front bump surface 443C and a rear bump surface 444C, at another side of the push bar 410C. The guide tabs 414C and 416C extend out from the front bump surfaces 441C and 443C, respectively. The front bump surfaces 441C and 443C extend in a first plane, the rear bump surfaces 442C and 444C extend in a second plane, and the front surface 413C of the contact bar 412C extends in a third plane. The first, second, and third planes extend parallel to each other in the example shown.

The elastic clips 420C and 422C are illustrated as a representative example in FIGS. 21A and 21B. The elastic clips 420C and 422C can be formed to other shapes and sizes in other embodiments. Referring between FIGS. 21A and 21B, the elastic clip 420C includes an elastic bar 421C and mounting ends 430C and 431C. The depicted mounting ends 430C and 431C are formed as right angle turns of the elastic bar 421C at the distal ends of the elastic bar 421C. The elastic clip 422C includes an elastic bar 423C and mounting ends 432C and 433C. The depicted mounting ends 432C and 433C are formed as right angle turns of the elastic bar 423C at the distal ends of the elastic bar 423C. It should be noted that while right angle shaped mounting ends are suitable, other shapes can also be provided to secure the elastic clips in the desired position.

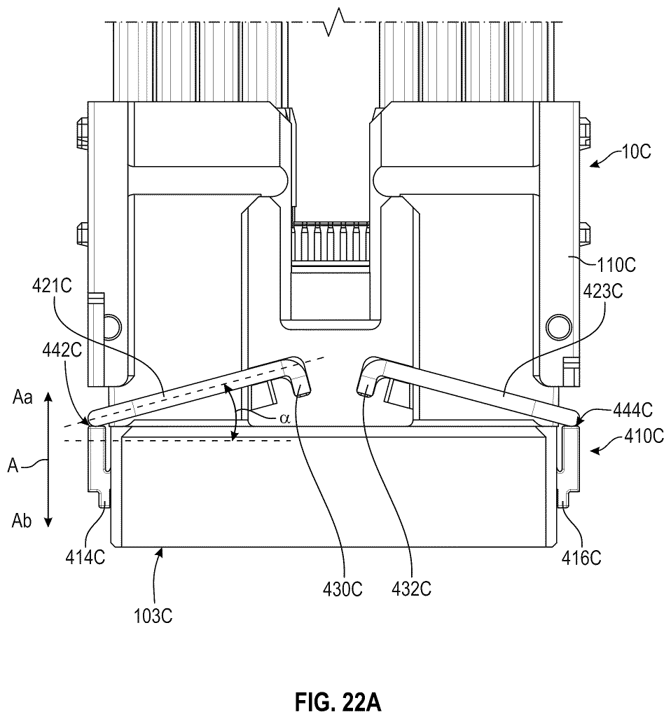

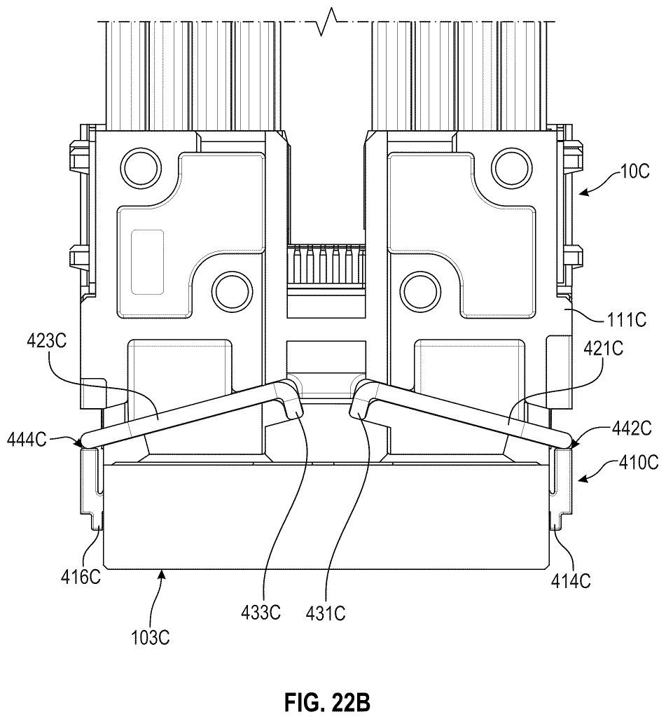

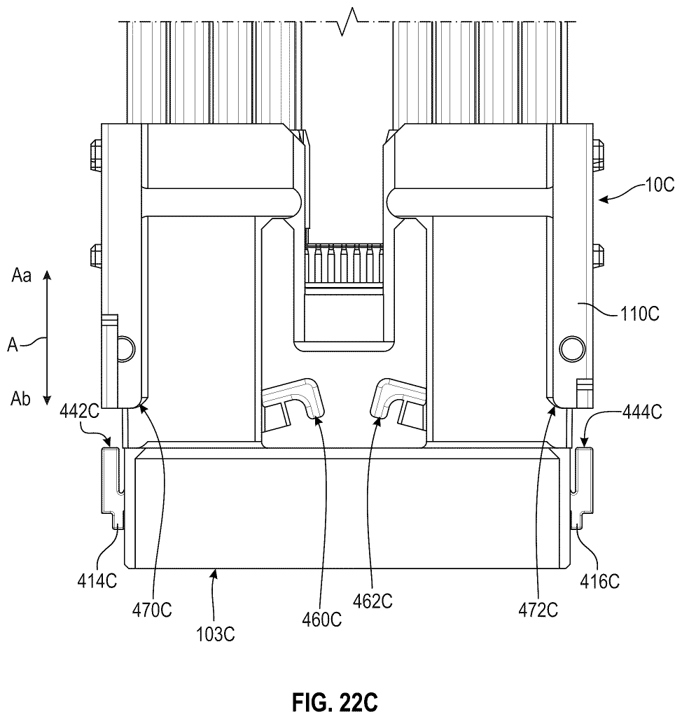

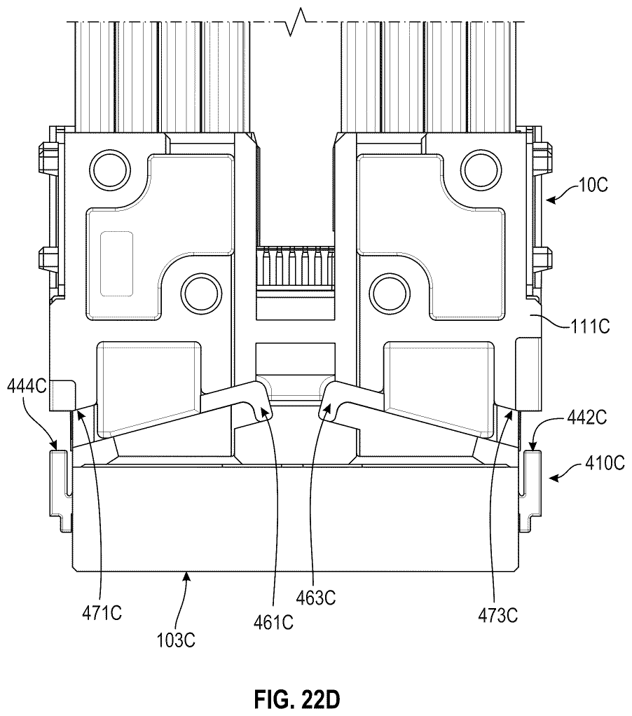

FIGS. 22A and 22B illustrate top and bottom views of the connector 10C shown in FIG. 19. FIGS. 22C and 22D illustrate top and bottom views of the connector 10C with the elastic clips 420C and 422C omitted from view. The top of the upper housing 110C of the connector 10C is shown in FIGS. 22A and 22C, and the bottom of the lower housing 111C of the connector 10C is shown in FIGS. 22B and 22D. FIGS. 22A-22D more clearly show how the elastic clips 420C and 422C are anchored to the upper and lower housings 110C and 111C.

Referring to FIGS. 22A and 22B, the elastic clips 420C and 422C are anchored to the upper and lower housings 110C and 111C at an angle a with respect to the front port face 103C of the housing. The angle a can vary among the embodiments, such as from 0-45 degrees, although other suitable angles can be relied upon. The elastic clips 420C and 422C are secured into anchor detents of the upper and lower housings 110C and 111C. For example, as shown in FIG. 22C, the upper housing 110C includes anchor detents 460C and 462C, which correspond in shape to the mounting ends 430C and 432C of the elastic clips 420C and 422C. Further, as shown in FIG. 22D, the lower housing 111C includes anchor detents 461C and 463C, which correspond in shape to the mounting ends 431C and 433C of the elastic clips 420C and 422C.

The anchor detents 460C, 461C, 462C, and 463C are formed as depressions in the upper and lower housings 110C and 111C. The anchor detents 460C, 461C, 462C, and 463C are formed to have a size and shape to accommodate the mounting ends 430C, 431C, 432C, and 433C of the elastic clips 420C and 422C, without a clearance (i.e., with an interference fit) or with only a nominal clearance between them. The elastic clips 420C and 422C can be installed placing the elastic clips 420C and 422C around and over the upper and lower housings 110C and 111C, with the mounting ends 430C, 431C, 432C, and 433C of the elastic clips 420C and 422C being placed and seated into the anchor detents 460C, 461C, 462C, and 463C of the upper and lower housings 110C and 111C.

When the connector 10C is assembled, the elastic clips 420C and 422C abut and contact the rear bump surfaces 442C and 444C of the push bar 410C, as shown in FIGS. 22A and 22B. In that configuration, the elastic clips 420C and 422C push the push bar 410C toward the front port opening 102C of the connector 10C. Based on the force provided by elastic clips 420C and 422C, the push bar 410C contacts and pushes against inner surfaces of the terminal conductors in the terminal rows 210CC and 310CC. The push bar 410C also maintains the contact tips of the terminal rows 210CC and 310CC a certain distance apart from each other, particularly when no paddle card is inserted into the front port opening 102C of the connector 10C. Consistent with the concepts described herein, the push bar 410C provides a predetermined and minimal clearance between the opposing contact tips of the terminal rows 210CC and 310CC.

When a paddle card is inserted into the front port opening 102C of the connector 10C, the front edge of the paddle card will contact and push against the contact bar 412C (see also FIG. 21B) of the push bar 410C. In turn, the push bar 410C will push against the elastic clips 420C and 422C and bend the elastic clips 420C and 422C back towards “Aa” in the direction “A” shown in FIGS. 21B and 22A. The push bar 410C will move deeper into the front port opening 102C against the elastic resistance provided by the elastic clips 420C and 422C. When moving deeper into the front port opening 102C, the push bar 410C will no longer contact the inner surfaces of the terminal conductors in the terminal rows 210CC and 310CC, and the tips of the terminal conductors will drop down according to the concepts described herein.

The elastic clips 420C and 422C can bend towards “Aa” in the direction “A” until contacting the bump corners 470C and 472C of the upper housing 110C and the bump corners 471C and 473C of the lower housing 111C. The bump corners 470C, 471, 472C, and 473C provide a backstop surface that prevents the elastic clips 420C and 422C from bending further. When the paddle card is removed from the connector 10C, then the elastic clips 420C and 422C can elastically return back to the form shown in FIGS. 22A and 22B. The elastic clips 420C and 422C will push the push bar 410C back towards “Ab” in the direction “A” shown in FIGS. 21B and 22A. When the push bar 410C moves back towards the position “Ab,” the push bar 410C will contact and push against inner surfaces of the terminal rows 210CC and 310CC, creating a minimal clearance between the opposing contact tips of the terminal rows 210CC and 310CC.

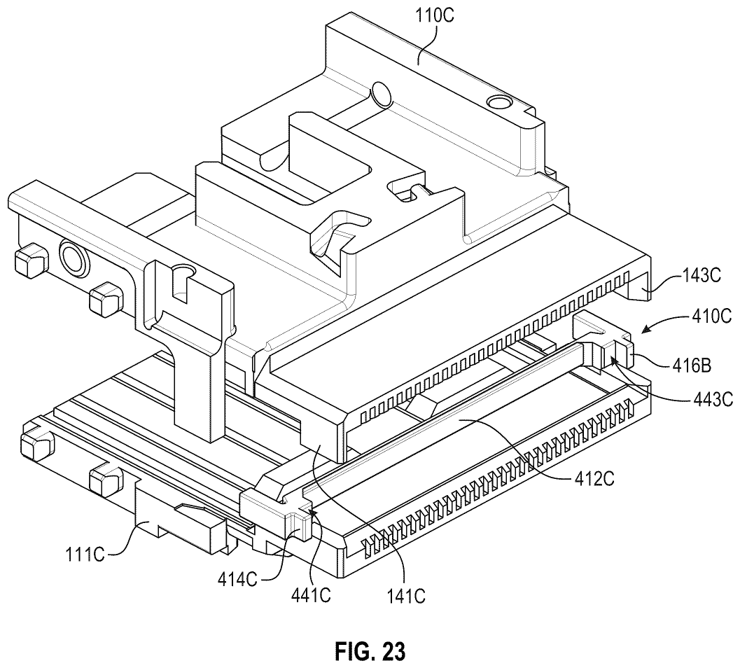

FIG. 23 illustrates a perspective view of the upper housing 110C, the lower housing 111C, and the push bar 410C of the connector 10C shown in FIG. 19. In the connector 10C, the push bar 410C is biased forward by the elastic clips 420C and 422C (see FIGS. 21A and 21B), as described above. The upper housing 110C includes sidewall posts 141C and 143C. When the connector 10C is assembled, the elastic clips 420C and 422C push the push bar 410C forward and into contact with the upper housing 110C. More particularly, the elastic clips 420C and 422C push the push bar 410C forward such that the front bump surfaces 441C and 443C of the push bar 410C contact the rear edges of the sidewall posts 141C and 143C of the upper housing 110C. In that position, the guide tabs 414C and 416C are positioned beside (and outside of) the sidewall posts 141C and 143C of the upper housing 110C. Contact between the front bump surfaces 441C and 443C of the push bar 410C and the rear edges of the sidewall posts 141C and 143C prevent the push bar 410C from moving forward any further than that shown in FIG. 19, although the push bar 410C is biased forward by the elastic clips 420C and 422C.

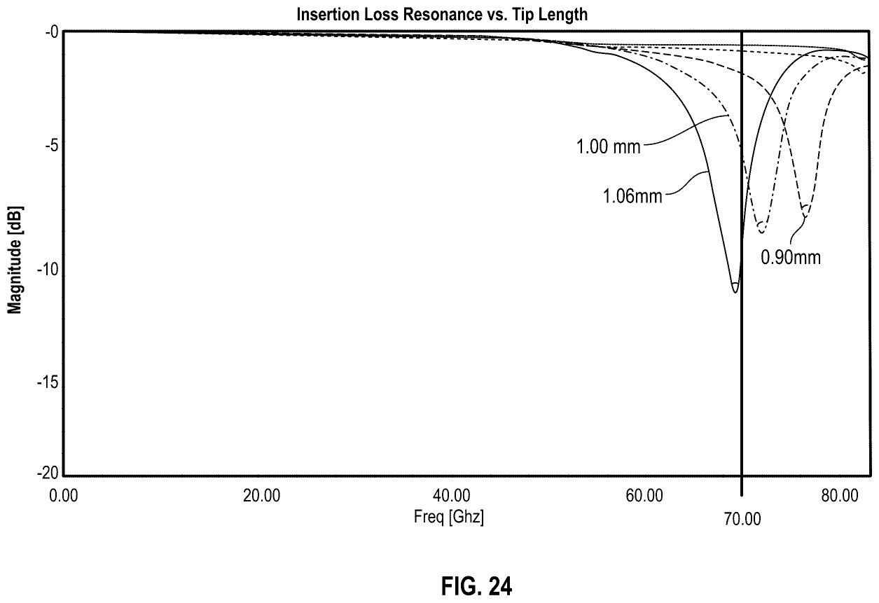

FIG. 24 illustrates an example chart of insertion loss resonance versus tip length for different tip lengths according to various embodiments of the present disclosure. As shown in FIG. 24, insertion loss resonance at an example frequency of 70 Ghz is greater for the tip length or open stub tip length of 1.06 mm than for 1.00 mm. Further, insertion loss resonance at 70 Ghz is greater for the tip length or open stub tip length of 1.00 mm than for 0.90 mm. Overall, the concepts described herein provide a way to shorten the contact tip length and stub length of terminal conductors and contact pads on paddle cards for improved signal integrity in electrical connectors. The results illustrated in FIG. 24 show one example of improvements in insertion loss, among other improvements, that can be achieved using the concepts described herein.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A connector, comprising:
a housing comprising a front port opening;
a wafer assembly comprising terminal rows; and
a push bar and a biasing component, wherein:
the terminal rows comprise a first row of terminal conductors and a second row of terminal conductors;
the push bar is positioned in the housing and extends between the first row of terminal conductors and the second row of terminal conductors; and
the biasing component pushes the push bar against the housing and into contact with the first row of terminal conductors and the second row of terminal conductors to maintain a minimal clearance between contact tips of the first row of terminal conductors and opposing contact tips of the second row of terminal conductors.

2. The connector of claim 1, wherein:
the biasing component pushes the push bar in a direction toward the front port opening of the housing to maintain the minimal clearance between the contact tips; and
when a paddle card is inserted into the front port opening, the paddle card pushes the push bar in a direction away from the front port opening and out of contact with the first row of terminal conductors and the second row of terminal conductors, so that the first row of terminal conductors and the second row of terminal conductors can drop down upon contact surfaces of the paddle card.

3. The connector of claim 1, wherein:
the minimal clearance is larger than a thickness of a paddle card for insertion into the front port opening; and
the contact tips of the first row of terminal conductors and the opposing contact tips of the second row of terminal conductors comprise drop down contact tips.

4. The connector of claim 1, wherein:
the housing comprises an upper housing and a lower housing; and
the biasing component comprises elastic members positioned between surfaces of the push bar and surfaces of the upper housing and the lower housing.

5. The connector of claim 1, wherein:
the housing comprises an alignment post; and
the biasing component pushes the push bar against an edge of the alignment post.

6. The connector of claim 1, wherein the biasing component comprises elastic clips.

7. The connector of claim 1, wherein the biasing component comprises elastic clips positioned around the housing.

8. The connector of claim 6, wherein the housing comprises anchor detents for securing the elastic clips around the housing.

9. The connector of claim 6, wherein the elastic clips comprise elastic bars and mounting ends.

10. The connector of claim 9, wherein:
the housing comprises an upper housing and a lower housing;
the upper housing comprises upper anchor detents and the lower housing comprises lower anchor detents; and
the mounting ends of the elastic clips are secured in the upper anchor detents and the lower anchor detents.

11. The connector of claim 9, wherein the elastic clips are anchored to the housing at an angle with respect to a front port face of the housing.

12. A connector, comprising:
a housing comprising a front port opening; and
a push bar and a biasing component, wherein:
the push bar extends between a first row of terminal conductors and a second row of terminal conductors the connector; and
the biasing component pushes the push bar into contact with the first row of terminal conductors and the second row of terminal conductors to maintain a minimal clearance between contact tips of the first row of terminal conductors and opposing contact tips of the second row of terminal conductors.

13. The connector of claim 12, wherein:
the minimal clearance is larger than a thickness of a paddle card for insertion into the front port opening; and
the contact tips of the first row of terminal conductors and the opposing contact tips of the second row of terminal conductors comprise drop down contact tips.

14. The connector of claim 12, wherein:
the housing comprises an upper housing and a lower housing; and
the biasing component comprises elastic members positioned between surfaces of the push bar and surfaces of the housing.

15. The connector of claim 12, wherein:
the housing comprises an upper housing and a lower housing;
at least one of the upper housing and the lower housing comprises an alignment post; and
the biasing component pushes the push bar against an edge of the alignment post.

16. The connector of claim 12, wherein the biasing component comprises elastic clips.

17. The connector of claim 12, wherein the biasing component comprises elastic clips positioned around the housing.

18. The connector of claim 16, wherein the housing comprises anchor detents for securing the elastic clips around the housing.

19. The connector of claim 16, wherein:
the elastic clips comprise elastic bars and mounting ends; and
the elastic clips are anchored to the housing at an angle with respect to a front port face of the housing.

20. The connector of claim 19, wherein:
the housing comprises an upper housing and a lower housing;
the upper housing comprises upper anchor detents and the lower housing comprises lower anchor detents; and
the mounting ends of the elastic clips are secured in the upper anchor detents and the lower anchor detents.
